(19) United States
(12) Patent Application Publication
(10) Pub. No.: US 2026/0343282 A1
(43) Pub. Date: Oct. 29, 2026

(54) TECHNIQUES FOR IDENTIFYING TIME DOMAIN OCCASIONS FOR BEAM PREDICTION

(71) Applicant: QUALCOMM INCORPORATED, San Diego, CA (US)

(72) Inventors: Qiaoyu LI, Beijing (CN); Mahmoud TAHERZADEH BOROUJENI, San Diego, CA (US); Tao LUO, San Diego, CA (US); Hamed PEZESHKI, San Diego, CA (US)

(21) Appl. No.: 19/102,369

(22) PCT Filed: Apr. 10, 2023
(86) PCT No.: PCT/CN2023/087213

§ 371 Date: Feb. 7, 2025

(30) Foreign Application Priority Data
Nov. 2, 2022 (WO) PCT/CN2022/129161

(51) Int. Cl. H04W 24/10; H04B 7/08; H04W 72/0446

(52) U.S. Cl. CPC H04W 24/10; H04B 7/088; H04W 72/0446

(57) ABSTRACT

Methods, systems, and devices for wireless communications are described. A user equipment (UE) may be configured to perform a first set of measurements on a set of reference signals received from a network entity, the first set of measurements associated with one or more receive beams at the UE used to receive the set of reference signals. The UE may predict, based on the first set of measurements, a second set of measurements (e.g., set of predicted channel characteristics) associated with a set of future time domain occasions determined in accordance with a reporting configuration, where the reporting configuration includes one or more parameters usable for determining the set of future time domain occasions. The UE may then transmit, to the network entity, a measurement report that is based on the second set of measurements predicted in accordance with the reporting configuration.

### CROSS REFERENCE

This application is a 371 National Stage of PCT Application No. PCT/CN2023/087213, filed on Apr. 10, 2023, entitled “TECHNIQUES FOR IDENTIFYING TIME DOMAIN OCCASIONS FOR BEAM PREDICTION”, and claims priority to International Patent Application No. PCT/CN2022/129161 by Li et al. entitled “TECHNIQUES FOR IDENTIFYING TIME DOMAIN OCCASIONS FOR BEAM PREDICTION,” filed Nov. 2, 2022, each of which is assigned to the assignee hereof, and each of which is expressly incorporated by reference in its entirety herein.

### FIELD OF TECHNOLOGY

The following relates to wireless communications, including techniques for identifying time domain occasions for beam prediction.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support the identifying of time domain occasions for beam prediction. Generally, aspects of the present disclosure are directed to techniques that wireless devices (e.g., user equipments (UEs), network entities) use to determine sets of future time domain occasions for beam measurement reporting. In particular, aspects of the present disclosure are directed to techniques for communicating or identifying “reporting configurations” for determining future time domain occasions for which a UE will predict and report future beam measurement predictions. For example, a UE may perform measurements on a set of reference signals received from the network, and may use the measurements to predict future measurements for future time domain occasions determined in accordance with a reporting configuration. Subsequently, the UE may transmit a measurement report (e.g., channel state information (CSI) report) indicating the predicted measurements for the future time domain occasions. In this example, the network may utilize the predicted measurements to schedule future communications with the UE.

A method is described. The method may include performing a first set of measurements on a set of reference signals received from a network entity, the first set of measurements associated with one or more receive (Rx) beams at the UE used to receive the set of reference signals, predicting, based on the first set of measurements, a second set of measurements associated with a set of future time domain occasions determined in accordance with a reporting configuration, where the reporting configuration includes one or more parameters usable for determining the set of future time domain occasions including a quantity of time domain occasions in the set of future time domain occasions, an earliest time domain occasion in the set of future time domain occasions, a latest time domain occasion in the set of future time domain occasions, one or more time intervals between the set of future time domain occasions, or any combination thereof, and transmitting, to the network entity, a measurement report indicating the second set of measurements predicted in accordance with the reporting configuration.

An apparatus is described. The apparatus may include a processor, memory coupled with the processor, and instructions stored in the memory. The instructions may be executable by the processor to cause the apparatus to perform a first set of measurements on a set of reference signals received from a network entity, the first set of measurements associated with one or more Rx beams at the UE used to receive the set of reference signals, predict, based on the first set of measurements, a second set of measurements associated with a set of future time domain occasions determined in accordance with a reporting configuration, where the reporting configuration includes one or more parameters usable for determining the set of future time domain occasions including a quantity of time domain occasions in the set of future time domain occasions, an earliest time domain occasion in the set of future time domain occasions, a latest time domain occasion in the set of future time domain occasions, one or more time intervals between the set of future time domain occasions, or any combination thereof, and transmit, to the network entity, a measurement report indicating the second set of measurements predicted in accordance with the reporting configuration.

Another apparatus is described. The apparatus may include means for performing a first set of measurements on a set of reference signals received from a network entity, the first set of measurements associated with one or more Rx beams at the UE used to receive the set of reference signals, means for predicting, based on the first set of measurements, a second set of measurements associated with a set of future time domain occasions determined in accordance with a reporting configuration, where the reporting configuration includes one or more parameters usable for determining the set of future time domain occasions including a quantity of time domain occasions in the set of future time domain occasions, an earliest time domain occasion in the set of future time domain occasions, a latest time domain occasion in the set of future time domain occasions, one or more time intervals between the set of future time domain occasions, or any combination thereof, and means for transmitting, to the network entity, a measurement report indicating the second set of measurements predicted in accordance with the reporting configuration.

A non-transitory computer-readable medium storing code is described. The code may include instructions executable by a processor to perform a first set of measurements on a set of reference signals received from a network entity, the first set of measurements associated with one or more Rx beams at the UE used to receive the set of reference signals, predict, based on the first set of measurements, a second set of measurements associated with a set of future time domain occasions determined in accordance with a reporting configuration, where the reporting configuration includes one or more parameters usable for determining the set of future time domain occasions including a quantity of time domain occasions in the set of future time domain occasions, an earliest time domain occasion in the set of future time domain occasions, a latest time domain occasion in the set of future time domain occasions, one or more time intervals between the set of future time domain occasions, or any combination thereof, and transmit, to the network entity, a measurement report indicating the second set of measurements predicted in accordance with the reporting configuration.

In some examples of the method, apparatuses, and non-transitory computer-readable medium described herein, the one or more parameters associated with the reporting configuration may be usable for determining time offsets between the set of future time domain occasions and a first transmission time interval (TTI) within which the measurement report may be transmitted, a second TTI associated with a reference resource for the measurement report, or both.

Some examples of the method, apparatuses, and non-transitory computer-readable medium described herein may further include operations, features, means, or instructions for transmitting, to the network entity, capability signaling indicating one or more reporting configurations supported by the UE and receiving, from the network entity based on the capability signaling, control signaling indicating the reporting configuration included within the one or more reporting configurations, where predicting the second set of measurements may be based on receiving the control signaling.

Some examples of the method, apparatuses, and non-transitory computer-readable medium described herein may further include operations, features, means, or instructions for receiving, from the network entity, control signaling indicating one or more reporting configurations including the reporting configuration, where predicting the second set of measurements may be based on receiving the control signaling.

Some examples of the method, apparatuses, and non-transitory computer-readable medium described herein may further include operations, features, means, or instructions for selecting the reporting configuration from the set of multiple reporting configurations based on a capability associated with the UE, a power level associated with the UE, one or more characteristics associated with message traffic to be communicated to or from the UE, or any combination thereof, where predicting the second set of measurements may be based on the selecting.

Some examples of the method, apparatuses, and non-transitory computer-readable medium described herein may further include operations, features, means, or instructions for transmitting, via the measurement report, an indication of the reporting configuration selected from the set of multiple reporting configurations.

Some examples of the method, apparatuses, and non-transitory computer-readable medium described herein may further include operations, features, means, or instructions for receiving, from the network entity, control signaling indicating the earliest time domain occasion in the set of future time domain occasions, the latest time domain occasion in the set of future time domain occasions, or both and determining the reporting configuration based on the control signaling, where predicting the second set of measurements may be based on the determining.

Some examples of the method, apparatuses, and non-transitory computer-readable medium described herein may further include operations, features, means, or instructions for receiving, via the control signaling, an indication of a first time domain offset associated with the earliest time domain occasion, a second time domain offset associated with the latest time domain occasion, or both, where the first time domain offset includes an offset between the earliest time domain occasion and the first TTI or a second TTI associated with a reference resource associated with the measurement report, and where the second time domain offset includes an offset between the latest time domain occasion and the first TTI or the second TTI, and where determining the reporting configuration may be based on the first time domain offset, the second time domain offset, or both.

Some examples of the method, apparatuses, and non-transitory computer-readable medium described herein may further include operations, features, means, or instructions for determining the quantity of time domain occasions in the set of future time domain occasions based on a time interval between the earliest time domain occasion and the latest time domain occasion.

Some examples of the method, apparatuses, and non-transitory computer-readable medium described herein may further include operations, features, means, or instructions for comparing the time interval to one or more threshold time durations, where determining the quantity of time domain occasions may be based on the comparison.

Some examples of the method, apparatuses, and non-transitory computer-readable medium described herein may further include operations, features, means, or instructions for transmitting an indication of the reporting configuration via the measurement report.

Some examples of the method, apparatuses, and non-transitory computer-readable medium described herein may further include operations, features, means, or instructions for receiving, from the network entity, control signaling indicating the quantity of time domain occasions within the set of future time domain occasions, a time interval between the earliest time domain occasion and the latest time domain occasion of the set of future time domain occasions, or both, determining the reporting configuration based on the quantity of time domain occasions, the time interval, or both, and transmitting, via the measurement report, an indication of the reporting configuration.

In some examples of the method, apparatuses, and non-transitory computer-readable medium described herein, the second set of measurements may be associated with the one or more Rx beams, one or more additional Rx beams at the UE, or both.

Some examples of the method, apparatuses, and non-transitory computer-readable medium described herein may further include operations, features, means, or instructions for receiving, from the network entity and based on the measurement report, control signaling scheduling message traffic between the UE and the network entity and communicating the message traffic with the network entity based on receiving the control signaling.

In some examples of the method, apparatuses, and non-transitory computer-readable medium described herein, the measurement report includes a CSI measurement report.

A method is described. The method may include transmitting a set of reference signals to a UE, receiving, from the UE based on transmitting the set of reference signals, a measurement report indicating a set of measurements associated with a set of future time domain occasions determined in accordance with a reporting configuration, where the reporting configuration includes one or more parameters usable for determining the set of future time domain occasions including a quantity of time domain occasions in the set of future time domain occasions, an earliest time domain occasion in the set of future time domain occasions, a latest time domain occasion in the set of future time domain occasions, one or more time intervals between the set of future time domain occasions, or any combination thereof, and transmitting, to the UE, control signaling scheduling message traffic between the UE and the network entity based on the set of measurements.

An apparatus is described. The apparatus may include a processor, memory coupled with the processor, and instructions stored in the memory. The instructions may be executable by the processor to cause the apparatus to transmit a set of reference signals to a UE, receive, from the UE based on transmitting the set of reference signals, a measurement report indicating a set of measurements associated with a set of future time domain occasions determined in accordance with a reporting configuration, where the reporting configuration includes one or more parameters usable for determining the set of future time domain occasions including a quantity of time domain occasions in the set of future time domain occasions, an earliest time domain occasion in the set of future time domain occasions, a latest time domain occasion in the set of future time domain occasions, one or more time intervals between the set of future time domain occasions, or any combination thereof, and transmit, to the UE, control signaling scheduling message traffic between the UE and the network entity based on the set of measurements.

Another apparatus is described. The apparatus may include means for transmitting a set of reference signals to a UE, means for receiving, from the UE based on transmitting the set of reference signals, a measurement report indicating a set of measurements associated with a set of future time domain occasions determined in accordance with a reporting configuration, where the reporting configuration includes one or more parameters usable for determining the set of future time domain occasions including a quantity of time domain occasions in the set of future time domain occasions, an earliest time domain occasion in the set of future time domain occasions, a latest time domain occasion in the set of future time domain occasions, one or more time intervals between the set of future time domain occasions, or any combination thereof, and means for transmitting, to the UE, control signaling scheduling message traffic between the UE and the network entity based on the set of measurements.

A non-transitory computer-readable medium storing code is described. The code may include instructions executable by a processor to transmit a set of reference signals to a UE, receive, from the UE based on transmitting the set of reference signals, a measurement report indicating a set of measurements associated with a set of future time domain occasions determined in accordance with a reporting configuration, where the reporting configuration includes one or more parameters usable for determining the set of future time domain occasions including a quantity of time domain occasions in the set of future time domain occasions, an earliest time domain occasion in the set of future time domain occasions, a latest time domain occasion in the set of future time domain occasions, one or more time intervals between the set of future time domain occasions, or any combination thereof, and transmit, to the UE, control signaling scheduling message traffic between the UE and the network entity based on the set of measurements.

In some examples of the method, apparatuses, and non-transitory computer-readable medium described herein, the one or more parameters associated with the reporting configuration may be usable for determining time offsets between the set of future time domain occasions and a first TTI within which the measurement report may be received, a second TTI associated with a reference resource for the measurement report, or both.

Some examples of the method, apparatuses, and non-transitory computer-readable medium described herein may further include operations, features, means, or instructions for receiving, from the UE, capability signaling indicating one or more reporting configurations supported by the UE and transmitting, to the UE based on the capability signaling, additional control signaling indicating the reporting configuration included within the one or more reporting configurations, where receiving the measurement report may be based on transmitting the additional control signaling.

Some examples of the method, apparatuses, and non-transitory computer-readable medium described herein may further include operations, features, means, or instructions for transmitting, to the UE, additional control signaling indicating one or more reporting configurations including the reporting configuration, where receiving the measurement report may be based on transmitting the additional control signaling.

Some examples of the method, apparatuses, and non-transitory computer-readable medium described herein may further include operations, features, means, or instructions for receiving, via the measurement report, an indication of the reporting configuration selected by the UE from the set of multiple reporting configurations.

Some examples of the method, apparatuses, and non-transitory computer-readable medium described herein may further include operations, features, means, or instructions for transmitting, to the UE, additional control signaling indicating the earliest time domain occasion in the set of future time domain occasions, the latest time domain occasion in the set of future time domain occasions, or both and determining the reporting configuration based on the additional control signaling, where receiving the measurement report may be based on the additional control signaling.

Some examples of the method, apparatuses, and non-transitory computer-readable medium described herein may further include operations, features, means, or instructions for transmitting, via the additional control signaling, an indication of a first time domain offset associated with the earliest time domain occasion, a second time domain offset associated with the latest time domain occasion, or both, where the first time domain offset includes an offset between the earliest time domain occasion and the first TTI or a second TTI associated with a reference resource associated with the measurement report, and where the second time domain offset includes an offset between the latest time domain occasion and the first TTI or the second TTI, and where determining the reporting configuration may be based on the first time domain offset, the second time domain offset, or both.

Some examples of the method, apparatuses, and non-transitory computer-readable medium described herein may further include operations, features, means, or instructions for determining the quantity of time domain occasions in the set of future time domain occasions based on a time interval between the earliest time domain occasion and the latest time domain occasion.

Some examples of the method, apparatuses, and non-transitory computer-readable medium described herein may further include operations, features, means, or instructions for comparing the time interval to one or more threshold time durations, where determining the quantity of time domain occasions may be based on the comparison.

Some examples of the method, apparatuses, and non-transitory computer-readable medium described herein may further include operations, features, means, or instructions for receiving an indication of the reporting configuration via the measurement report.

Some examples of the method, apparatuses, and non-transitory computer-readable medium described herein may further include operations, features, means, or instructions for transmitting, to the UE, additional control signaling indicating the quantity of time domain occasions within the set of future time domain occasions, a time interval between the earliest time domain occasion and the latest time domain occasion of the set of future time domain occasions, or both and receiving, via the measurement report, an indication of the reporting configuration, where the reporting configuration may be based on the quantity of time domain occasions, the time interval, or both.

In some examples of the method, apparatuses, and non-transitory computer-readable medium described herein, the measurement report includes a CSI measurement report.

### BRIEF DESCRIPTION OF THE DRAWINGS

FIG. 1 illustrates an example of a wireless communications system that supports techniques for identifying time domain occasions for beam prediction in accordance with one or more aspects of the present disclosure.

FIG. 2 illustrates an example of a wireless communications system that supports techniques for identifying time domain occasions for beam prediction in accordance with one or more aspects of the present disclosure.

FIG. 3 illustrates an example of a resource configuration that supports techniques for identifying time domain occasions for beam prediction in accordance with one or more aspects of the present disclosure.

FIG. 4 illustrates an example of a process flow that supports techniques for identifying time domain occasions for beam prediction in accordance with one or more aspects of the present disclosure.

FIGS. 5 and 6 illustrate block diagrams of devices that support techniques for identifying time domain occasions for beam prediction in accordance with one or more aspects of the present disclosure.

FIG. 7 illustrates a block diagram of a communications manager that supports techniques for identifying time domain occasions for beam prediction in accordance with one or more aspects of the present disclosure.

FIG. 8 illustrates a diagram of a system including a device that supports techniques for identifying time domain occasions for beam prediction in accordance with one or more aspects of the present disclosure.

FIGS. 9 and 10 illustrate block diagrams of devices that support techniques for identifying time domain occasions for beam prediction in accordance with one or more aspects of the present disclosure.

FIG. 11 illustrates a block diagram of a communications manager that supports techniques for identifying time domain occasions for beam prediction in accordance with one or more aspects of the present disclosure.

FIG. 12 illustrates a diagram of a system including a device that supports techniques for identifying time domain occasions for beam prediction in accordance with one or more aspects of the present disclosure.

FIGS. 13 through 15 illustrate flowcharts showing methods that support techniques for identifying time domain occasions for beam prediction in accordance with one or more aspects of the present disclosure.

### DETAILED DESCRIPTION

Some wireless devices (e.g., user equipment (UEs)) may be configured to receive reference signals from the network using different receive (Rx) beams, and perform measurements on the received reference signals in order to identify relative qualities of the respective Rx beams. In such cases, the UEs may transmit measurement reports (e.g., channel state information (CSI) reports) to the network indicating the measurements so that the network can schedule communications at the UE using Rx beams that are best for the UE (e.g., exhibit a threshold quality). In some cases, UEs may utilize past measurements to predict beam measurements (e.g., future Rx beam qualities) at some point in the future, and may report the predicted/extrapolated beam measurements to the network. However, conventional techniques are silent with respect to how far into the future the UE is expected to make measurement predictions, a quantity of measurement predictions the UE is expected to make, etc. Without such information, it may be unclear as to which predicted measurements reported to the network correspond to which future time intervals, which may result in inefficient and ineffective scheduling for communications at the UE.

Accordingly, various aspects of the present disclosure generally relate to techniques that enable the network and UEs to determine sets of future time domain occasions for beam measurement reporting. Some aspects more specifically relate to techniques for communicating or identifying “reporting configurations” for determining future time domain occasions for which the UE will predict and report future beam measurement predictions. In some examples, a UE may perform measurements on a set of reference signals received from the network, and may use the measurements to predict future measurements (e.g., predict future channel characteristics) for future time domain occasions determined in accordance with a reporting configuration. Subsequently, the UE may transmit a measurement report (e.g., CSI report) indicating the predicted measurements (e.g., predicted channel characteristics) for the future time domain occasions. In this example, the network may utilize the predicted measurements to schedule future communications with the UE so that the UE may perform the future communications using Rx beams that are expected/predicted to exhibit sufficient performance.

Reporting configurations for identifying time domain occasions for beam prediction may be preconfigured, signaled or configured by the network, and/or based on UE capabilities. For example, the UE may report its capabilities, and the network may indicate one or more reporting configurations for determining time domain occasions that comply with the reported UE capabilities. In some cases, the UE may select a reporting configuration from a set of (configured/signaled) reporting configurations, and may indicate the selected reporting configuration via the measurement report.

Particular aspects of the subject matter described in this disclosure may be implemented to realize one or more of the following potential advantages. In some examples, by enabling wireless devices to determine reporting configurations that will be used for future beam prediction, the described techniques may be used to improve coordination between the network and wireless devices. By providing signaling, rules, and/or conditions usable for determining reporting configurations, techniques described herein may enable the network and the UE to use the same reporting configuration to determine which predicted measurements/channel characteristics reported by the UE correspond to which future time domain occasions, which may enable the network to more efficiently and reliably schedule communications at the UE. In particular, aspects of the present disclosure may enable the network to schedule future communications at the UE such that the UE will perform the future scheduled communications using Rx beams that are expected/predicted to exhibit sufficient performance.

Aspects of the disclosure are initially described in the context of wireless communications systems. Additional aspects of the disclosure are described in the context of an example resource configuration and an example process flow. Aspects of the disclosure are further illustrated by and described with reference to apparatus diagrams, system diagrams, and flowcharts that relate to techniques for identifying time domain occasions for beam prediction.

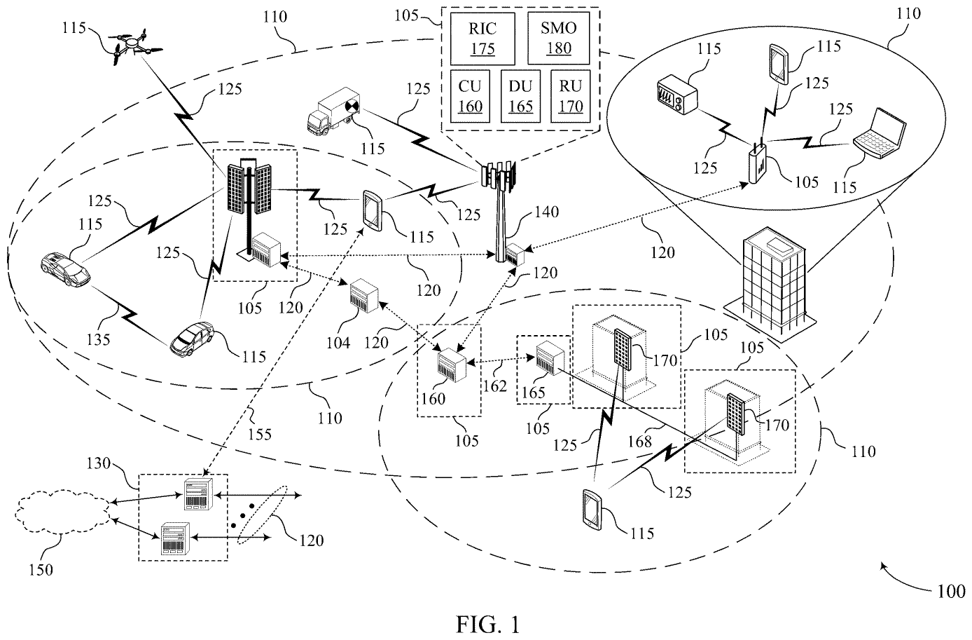

FIG. 1 illustrates an example of a wireless communications system 100 that supports techniques for identifying time domain occasions for beam prediction in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125.

The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more Dus 165 or RUS 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more Dus 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more Dus 165 or one or more RUs 170 may be partially controlled by one or more Cus 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by Dus 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include Dus 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other Cus 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., Dus 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the Dus 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support techniques for identifying time domain occasions for beam prediction as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit (Tx) beam, a receive (Rx) beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information (CSI) reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some implementations, wireless devices (e.g., UEs 115, network entities 105, IAB nodes, etc.) of the wireless communications system 100 may support techniques that enable the wireless devices to determine sets of future time domain occasions for beam measurement reporting. In particular, the wireless communications system 100 may support techniques for communicating or identifying “reporting configurations” for determining future time domain occasions for which UEs 115 will predict and report future beam measurement predictions.

For example, a UE 115 of the wireless communications system 100 may perform measurements on a set of reference signals received from the network, and may use the measurements to predict future measurements for future time domain occasions determined in accordance with a reporting configuration. Subsequently, the UE 115 may transmit a measurement report (e.g., CSI report) indicating the predicted measurements for the future time domain occasions. In this example, the network may utilize the predicted measurements to schedule future communications with the UE 115 so that the UE 115 may perform the future communications using Rx beams that are expected/predicted to exhibit sufficient performance.

Reporting configurations for identifying time domain occasions for beam prediction may be preconfigured, signaled or configured by the network, and/or based on UE capabilities. For example, the UE may report its capabilities, and the network may indicate one or more reporting configurations for determining time domain occasions that comply with the reported UE 115 capabilities. In some cases, the UE 115 may select a reporting configuration from a set of (configured/signaled) reporting configurations, and may indicate the selected reporting configuration via the measurement report.

Techniques described herein may enable wireless devices to determine reporting configurations that will be used for future beam prediction, which may improve coordination between the network and wireless devices. By providing signaling, rules, and/or conditions usable for determining reporting configurations, techniques described herein may enable the network and the UE 115 to use the same reporting configuration to determine which predicted measurements reported by the UE 115 correspond to which future time domain occasions, which may enable the network to more efficiently and reliably schedule communications at the UE 115. In particular, aspects of the present disclosure may enable the network to schedule future communications at the UE 115 such that the UE 115 will perform the future scheduled communications using Rx beams that are expected/predicted to exhibit sufficient performance.

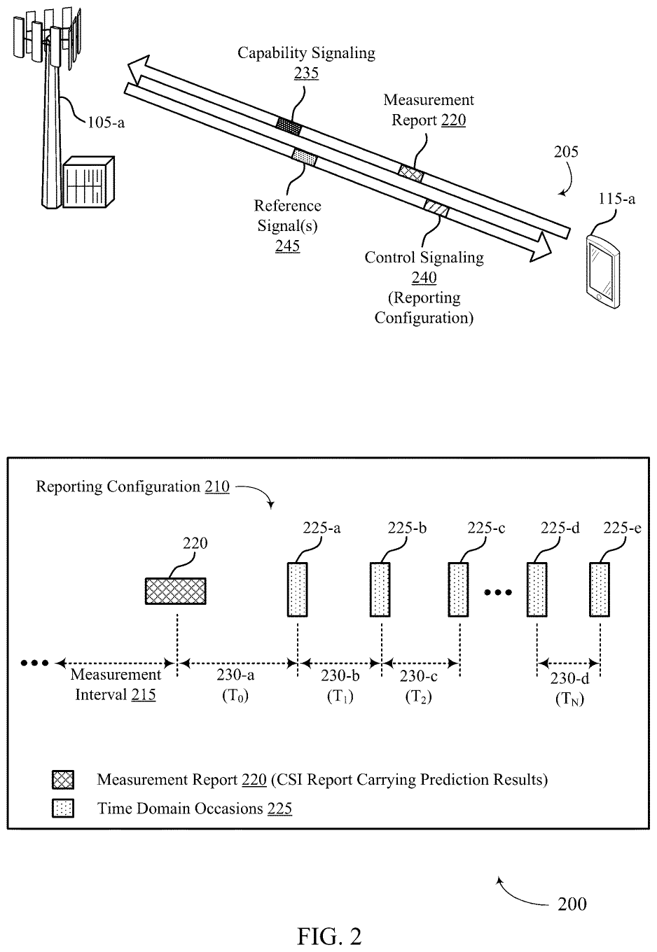

FIG. 2 illustrates an example of a wireless communications system 200 that supports techniques for identifying time domain occasions for beam prediction in accordance with one or more aspects of the present disclosure. In some examples, aspects of the wireless communications system 200 may implement, or be implemented by, aspects of the wireless communications system 100. In particular, the wireless communications system 200 may support techniques for determining or signaling measurement configurations for future time-domain beam prediction, as described previously herein.

The wireless communications system 200 may include a UE 115-a and a network entity 105-a, which may be examples of wireless devices as described herein. In some aspects, the UE 115-a and the network entity 105-a may communicate with one another using a communication link 205, which may be an example of an NR or LTE link, a sidelink (e.g., PC5 link), and the like, between the respective devices. In some cases, the communication link 205 may include an example of an access link (e.g., Uu link) which may include a bi-directional link that enables both uplink and downlink communication. For example, the UE 115-a may transmit uplink signals, such as uplink control signals or uplink data signals, to one or more components of the network entity 105-a using the communication link 205, and one or more components of the network entity 105-a may transmit downlink signals, such as downlink control signals or downlink data signals, to the UE 115-a using the communication link 205.

As noted previously herein, some wireless devices (e.g., UEs 115) may be configured to receive reference signals from the network using different Rx beams, and perform measurements on the received reference signals in order to identify relative qualities of the respective Rx beams. In such cases, the UEs 115 may transmit measurement reports (e.g., CSI reports) to the network indicating the measurements so that the network can schedule communications at the UE 115 using Rx beams that are best for the UE 115 (e.g., Rx beams that exhibit a threshold quality).

In some cases, UEs 115 may utilize past measurements to predict beam measurements (e.g., future Rx beam qualities) at some point in the future, and may report the predicted/extrapolated beam measurements to the network. In some cases, machine learning techniques (e.g., long short-term memory (LSTM) based deep learning techniques) may be used to perform beam measurement prediction/extrapolation. For example, in some cases, measurements (e.g., reference signal received power (RSRP) measurements) performed by a UE 115 and/or a network entity 105 may be input into a machine learning model (e.g., RSRP predictor) including one or more LSTM layers or cells. In this example, the cell and hidden states of each LSTM cell layer may be recursively used by subsequent LSTM layers, where the machine learning model is configured to output predicted beam measurements for the UE 115 (e.g., UE-based RSRP predictions) and/or the network entity 105 (e.g., network-based RSRP predictions). In some cases, predicted beam measurements outputted by the machine learning model may be re-input into the model in order to further train the model and improve the ability of the model to perform future predictions.

However, conventional techniques for performing future beam predictions are deficient. In particular, conventional techniques are silent with respect to how far into the future the UE 115 is expected to make measurement predictions, a quantity of measurement predictions the UE 115 is expected to make, etc. Without such information, it may be unclear as to which predicted measurements reported to the network correspond to which future time intervals, which may result in inefficient and ineffective scheduling for communications at the UE 115. In other words, using conventional techniques, time domain intervals between adjacent time domain occasions are not clearly defined, which may limit the utility of future beam prediction techniques.

Accordingly, the wireless communications system 200 may support techniques that enable the network entity 105-a and the UE 115-a to determine sets of future time domain occasions for beam measurement reporting. In particular, aspects of the present disclosure may support techniques for communicating or identifying “reporting configurations” for determining future time domain occasions for which the UE 115-a will predict and report future beam measurement predictions (e.g., predicted future channel characteristics). In other words, the reporting configurations described herein may clarify relative quantities and timings of future time domain occasions so that the UE 115-a and the network entity 105-a may be on the same page with respect to which reported measurement predictions correspond to which future time domain occasions.

For the purposes of the present disclosure, predictions performed by the UE 115-a for future time domain occasions may be referred to as “measurements” even though the predicted measurements are not “measured” by the UE 115-a in a strict sense, but are rather a prediction of a channel characteristic during the respective future time domain occasions. In other words, the UE 115-a may be said to predict “measurements” for the future time domain occasions in that the UE 115-a performs a prediction of measurements that would be theoretically performed by the UE 115-a during the future time domain occasions (e.g., if the UE 115-a were to communicate during the future time domain occasions, these are the measurements/channel characteristics the UE 115-a would likely observe). In this regard, the terms “predicted measurements,” “beam predictions,” “predicted channel characteristics,” and like terms, may be used interchangeably to refer to predictions the UE 115-a makes for future time domain occasions. For example, the UE 115-a can predict RSRP/RSRQ values for a channel between the UE 115-a and the network entity 105-a during the future time domain occasions, which resources or beams will be best for communicating over the channel during the future time domain occasions, etc.

As will be described in further detail herein, reporting configurations may be determined and/or exchanged between the UE 115-a and the network entity 105-a using a variety of implementations. In accordance with a first implementation, relevant standards associated with the wireless communications system 200 may define (e.g., predefine) one or more candidate reporting configurations that define a number of time domain interval options between adjacent future time domain occasions. In such cases, the network (e.g., network entity 105-a) may preconfigure or indicate one of the defined reporting configurations when configuring, activating, or otherwise triggering the UE 115-a to perform CSI reporting.

In accordance with a second implementation, the UE 115-a may pre-report its capabilities related to supported time domain interval options (e.g., indicate supported reporting configurations, processing/memory capabilities, etc.), in which case the UE 115-a would only expect to be configured/indicated to perform future beam prediction (e.g., future channel characteristic prediction) in accordance with the indicated capabilities. In such cases, the UE 115-a may be configured to report separate sets of capabilities for differing quantities of future time domain occasions that are to be predicted.

In accordance with a third implementation, the network entity 105-a may preconfigure/indicate multiple reporting configurations (including multiple time domain interval options) and/or parameters for a reporting configuration that is to be used for a CSI report to be generated by the UE 115-a. In such cases, the UE 115-a may be expected to report predicted measurements/predicted channel characteristics for the time domain occasions determined in accordance with the indicated/determined reporting configuration. In cases where the network indicates multiple candidate reporting configurations, the UE 115-a may further report (via the CSI report) which reporting configuration was used to generate the CSI report payload (e.g., which reporting configuration was used to determine the future beam predictions/channel characteristic predictions).

For example, as shown in FIG. 2, the UE 115-a may transmit capability signaling 235 to the network entity 105-a. The capability signaling 235 may indicate one or more capabilities associated with the ability of the UE 115-a to perform future beam predictions, such as supported reporting configurations 210, processing capabilities, memory capabilities, and the like. For example, the capability signaling 235 may indicate one or more reporting configurations 210 usable for determining sets of future time domain occasions 225 that are supported by the UE 115-a.

For the purposes of the present disclosure, the term “reporting configuration 210” (e.g., CSI reporting configuration 210) may refer to a set of rules, conditions, and/or parameters usable by the respective devices to determine or identify sets of future time domain occasions 225 that will be used for future beam prediction (e.g., future channel characteristic prediction). In other words, reporting configurations 210 may be usable by the respective devices for determining time domain intervals (and time domain occasions 225 within the respective time domain intervals) that the UE 115-a is expected to predict and report beam measurements (e.g., predicted and reported Layer 1 (L1) RSRP measurements, L1-SINR measurements, etc.).

In some cases, the UE 115-a may pre-report its capabilities regarding supported reporting configurations 210 (and/or supported time domain intervals for beam prediction) based on predefined standard capabilities. For example, a capability signaling value of “1” may indicate that the UE 115-a supports reporting configurations 210 associated with ReportingConfigIDs #1 and #2, where the ReportingConfigIDs may be predefined or signaled to the UE 15-a. Such capability reporting may be further based on standard reporting configurations 210 associated with different total quantities of future time domain occasions 225 to be precited and indicated via a CSI report (e.g., measurement report 220). In other words, the UE 115-a may indicate that it supports reporting configurations 210 that include ten or fewer time domain occasions 225.

As will be described in further detail herein, the reporting configuration 210 usable by the respective devices may be determined or selected according to various implementations, such as via preconfiguration in relevant standards, based on network configuration and/or indication, based on UE capability reporting (e.g., capability signaling 235), UE 115-a self-determination and reporting via a CSI report, and the like.

For example, in some cases, the wireless communications system 200 may be associated with standard, predefined time domain interval options (e.g., standard/predefined reporting configurations 210) for future beam reporting. In other words, relevant standards associated with the wireless communications system 200 may predefine a number of reporting configuration 210 options related to time domain intervals that will be used for future beam prediction. In such cases, each predefined reporting configuration 210 may define one or more parameters for determining time domain occasions 225 for which the UE 115-a will perform future measurement prediction (e.g., future channel characteristic prediction). For example, each reporting configuration 210 may include or define the total quantity of future time domain occasions 225 that are to be addressed in the measurement report 220, the time domain occasion 225 associated with the nearest future time domain occasion 225 to be addressed in the measurement report 220 (e.g., earliest time domain occasion 225-a), time intervals 230 between each respective adjacent pair of future time domain occasions 225 (e.g., {T₁, T₂, . . . , T_{N}}), and the like. In some cases, the earliest time domain occasion 225-a may be further defined based on a time domain offset (e.g., time interval 230-a) between the earliest time domain occasion 225-a and the TTI/slot carrying the CSI report, or the TTI/slot carrying the CSI reference resource associated with the CSI reporting occasion.

Additionally, or alternatively, the reporting configuration 210 may indicate what is to be reported for the respective time domain occasions 225 via the measurement report 220. For example, the reporting configuration 210 may indicate whether the measurement report 220 is to indicate actual performed/predicted channel characteristics, whether the measurement report 220 is to indicate the K quantity of beams/resources that satisfy some threshold (e.g., report the K best beams predicted for each time domain occasions 225), etc. For instance, the reporting configuration 210 may indicate that reported prediction quantities (as indicated by measurement reports 220) are to include the predicted top-K-resources in terms of L1-RSRP/L1-SINR strengths for the respective resources, without indicating the actual L1-RSRP/L1-SINR values.

By way of another example, in some implementations, the network entity 105-a may determine or select one or more reporting configurations 210 that may be used for future beam measurements/prediction at the UE 115-a. Additionally, or alternatively, the network entity 105-a may determine/select one or more parameters for a reporting configuration 210, such as a quantity of time domain occasions 225 that are to be predicted, relative timings of the earliest time domain occasion 225-a and/or latest time domain occasion 225-d, time intervals 230 between time domain occasions 225, and the like.

In some implementations, relative timings (e.g., time intervals 230) of time domain occasions 225 used for future beam prediction may be determined relative to a TTI/slot in which a measurement report 220 (e.g., CSI report) is communicated (e.g., slot including CSI report indicating prediction results), and/or relative to a TTI/slot associated with a reference resource (e.g., CSI reference resource) for the measurement report 220.

In some cases, the network entity 105-a may determine/select the one or more reporting configurations 210 (and/or parameters for the reporting configuration 210(s)) based on the capability signaling 235. For example, the capability signaling 235 may indicate a set of reporting configurations 210 that are supported by the UE 115-a, and the network entity 105-a may select a subset of the reporting configurations 210 as “candidate” reporting configurations 210 that may be used by the UE 115-a.

In some aspects, the UE 115-a may receive, from the network entity 105-a, control signaling 240 (e.g., RRC, system information block (SIB), downlink control information (DCI), MAC control element (MAC-CE)) indicating one or more reporting configurations 210, one or more parameters for a reporting configuration 210, or both. In some aspects, the UE 115-a may receive the control signaling 240 based on transmitting the capability signaling 235.

For example, in cases where the network entity 105-a selects a set of candidate reporting configurations 210, the control signaling 240 may indicate the set of candidate reporting configurations 210. By way of another example, in other cases, the control signaling 240 may indicate one or more parameters usable by the UE 115-a for selecting/determining a reporting configuration 210 that will be used, such as a quantity of time domain occasions 225 that are to be predicted, relative timings of earliest/latest time domain occasions 225, time intervals 230 between time domain occasions 225, time domain offsets for sets of future time domain occasions 225, and the like.

In cases where the reporting configuration(s) 210 used for future beam prediction is determined/selected based on network configuration or indication, the signaling used by the network entity 105-a to indicate the reporting configuration 210 options may vary based on the type of CSI reporting (e.g., measurement report 220) to be performed by the UE 115-a. For example, in the case of periodic CSI (P-CSI) reports, semi-persistent CSI (SP-CSI) reports, and/or aperiodic CSI (AP-CSI) reports, the network entity 105-a may preconfigure the options for the reporting configuration(s) 210 that are to be used in the CSI report setting associated with the CSI report. For instance, RRC configuration of a CSI report setting may enable the network entity 105-a to indicate/configure one or more predefined reporting configuration 210 options.

By way of another example, in the context of SP-CSI reports, the network entity 105-a may indicate the reporting configuration(s) 210 that will be used via a MAC-CE message which activates/triggers the CSI report (e.g., MAC-CE triggering the measurement report 220). For instance, the network entity 105-a may use a MAC-CE activation command of an SP CSI report setting to indicate one or more predefined reporting configuration 210 options, or to indicate one or more reporting configuration 210 options that are preconfigured in the CSI report setting. Further, by way of yet another example, in the context of an AP-CSI report, the network entity 105-a may indicate the reporting configuration(s) 210 to be used by preconfiguring the options in the CSI-AssociatedReportConfigInfo with respect to a certain AP-CSI report, and may trigger such options when the UE 115-a is requested to generate the AP-CSI report via DCI signaling (e.g., DCI signaling may indicate the reporting configuration(s) 210 to be used for the AP CSI report). For instance, the network entity 105-a may use the CSI-AssociatedReportConfigInfo of an AP-CSI report to preconfigure one or more reporting configuration 210 options, or indicate a reporting configuration 210 that is preconfigured in the CSI report setting.

In some aspects, the UE 115-a may determine/select the reporting configuration 210 (and/or additional parameters for the reporting configuration 210) that will be used for future beam prediction. In other words, the UE 115-a may be configured to identify the earliest time domain occasion 225-a, as well as time intervals 230 among/between each pair of adjacent time domain occasions 225. Stated differently, the UE 115-a may use the reporting configuration 210 to identify the future time domain occasions 225 for which the UE 115-a is expected to predict beam measurements.

The UE 115-a may determine/select the reporting configuration 210 based on transmitting the capability signaling 235, receiving the control signaling 240, or both. For example, in cases where the control signaling 240 indicates a single reporting configuration 210, the UE 115-a may be expected to utilize the indicated reporting configuration 210 to perform the predictions and generate the measurement report 220 (e.g., CSI report).

By way of another example, in cases where the control signaling 240 indicates a set of candidate reporting configurations 210, the UE 115-a may select one of the candidate reporting configurations 210. In other cases where the control signaling 240 indicates one or more parameters for a reporting configuration 210, the UE 115-a may select a reporting configuration 210 that is associated with (e.g., satisfies, includes) the indicated parameters. For instance, the control signaling 240 may indicate time domain offsets for the earliest time domain occasion 225-a and/or the latest time domain occasion 225-e in the set of future time domain occasions 225 used for future beam prediction. In this example, the UE 115-a may determine a quantity of time domain occasions 225 of the reporting configuration 210 based on the time domain offsets for the earliest/latest time domain occasions 225, relative time intervals 230 (e.g., time intervals 230-a, 230-b, 230-c, 230-d) between the respective time domain occasions 225, and the like.

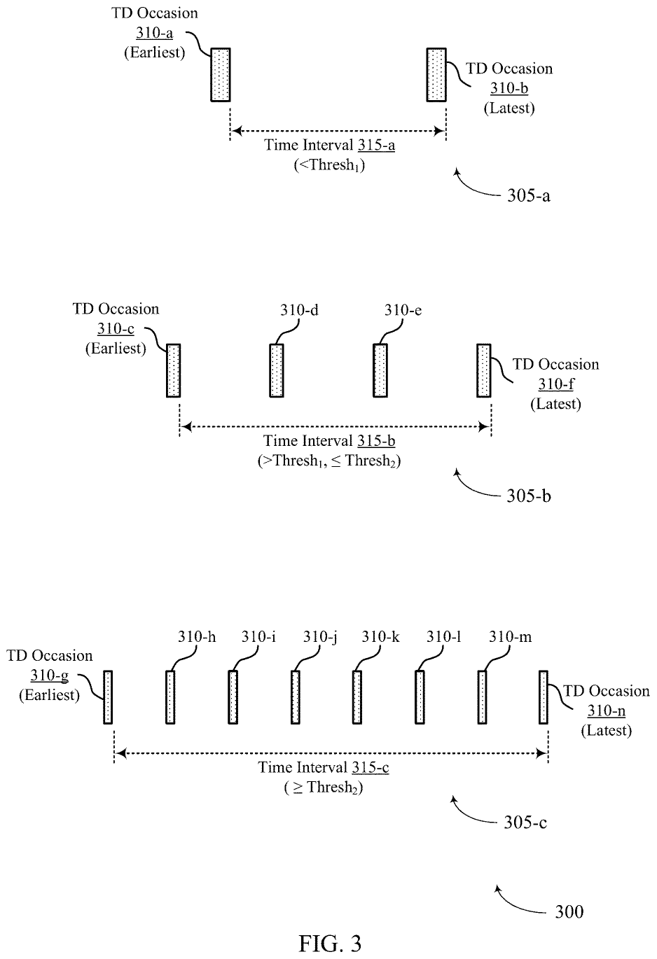

Additional details used by the network entity 105-a and the UE 115-a to indicate and/or determine parameters of reporting configurations 210 will be further shown and described with respect to FIG. 3.

In some aspects, the UE 115-a may select/determine the reporting configuration 210 that will be used based on additional or alternative characteristics/parameters, such as a capability of the UE 115-a (e.g., processing capability, memory capability), a power level of the UE 115-a (e.g., battery level), characteristics of message traffic to be communicated to/from the UE 115-a (e.g., relative priority/importance of future communications, quality of service (QOS)), or any combination thereof.

The UE 115-a may receive one or more reference signals 245 (e.g., CSI-RSs) from the network entity 105-a. In some cases, the reference signals 245 may be received within channel measurement resources (CMRs) which may be preconfigured and/or signaled to the UE 115-a (e.g., via the control signaling 240). For example, the UE 115-a may receive the reference signals 245 within CMRs included within a measurement interval 215 prior to the TTI/slot that the UE 115-a is expected to transmit the measurement report 220. In this regard, the measurement interval 215 may be defined relative to the TTI/slot including the CSI report, relative to the TTI/slot including the CSI reference resource (which may precede the CSI report), or both.

In some cases, the UE 115-a may receive the reference signals 245 using one or more Rx beams at the UE 115-a. For example, the UE 115-a may cycle through a set of Rx beams to receive the reference signals 245 in order to evaluate a relative effectiveness or quality of the respective Rx beams for communicating with the network entity 105-a.

The UE 115-a may perform a first set of measurements on the reference signals 245 received within the measurement interval 215. The first set of measurements may include, but are not limited to, RSRP measurements (e.g., L1-RSRPs), SINR measurements (e.g., L1-SINRs), SNR measurements, reference signal received quality (RSRQ) measurements, channel quality indicator (CQI) measurements, or any combination thereof. The UE 115-a may perform the first set of measurements order to evaluate a relative effectiveness or quality of the respective Rx beams for communicating with the network entity 105-a. For example, the UE 115-a may perform measurements for each respective Rx beam that was used to receive the reference signals 245.

In some aspects, the UE 115-a may predict a second set of measurements (e.g., predict a set of channel characteristics) associated with the set of future time domain occasions 225 determined in accordance with the determined/indicated reporting configuration 210. In other words, the UE 115-a may predict measurements or channel characteristics (e.g., RSRP, SINR, SNR, RSRQ, CQI) for each respective time domain occasion 225 associated with the determined reporting configuration 210.

Moreover, the second set of predicted measurements (e.g., set of precited channel characteristics) may include predicted measurements associated with the same or different Rx beams which were used to receive the reference signals 245 within the measurement interval 215.

For example, as shown in FIG. 2, the reporting configuration 210 may include (or define, indicate) five separate future time domain occasions 225-a, including a first/earliest time domain occasion 225-a, a second time domain occasion 225-b, a third time domain occasion 225-c, a fourth time domain occasion 225-d, and a fifth/latest time domain occasion 225-e. In this example, the UE 115-a may predict five measurements/channel characteristics (and/or five sets of measurements/channel characteristics) in accordance with the reporting configuration 210, with one predicted measurement (and/or one predicted set of measurements) for each respective time domain occasion 225 (e.g., first predicted measurement(s)/channel characteristic(s) for the first time domain occasion 225-a, second predicted measurement(s)/channel characteristic(s) for the second time domain occasion 225-b, etc.).

For instance, the UE 115-a may be configured to predict measurements for three different Rx beams. In this example, the UE 115-a may predict a first set of three predicted measurements (one for each Rx beam) for the first time domain occasion 225-a, a second set of three predicted measurements for the second time domain occasion 225-b, a third set of three predicted measurements for the third time domain occasion 225-c, etc.

In some aspects, the UE 115-a may transmit, to the network entity 105-a, a measurement report 220 (e.g., CSI report) that indicates the second set of measurements which were predicted for the future time domain occasions 225. The measurement report 220 may additionally or alternatively indicate the first set of measurements which were performed on the reference signals 245 received within the measurement interval 215. Moreover, in some cases, the measurement report 220 may indicate CMR IDs associated with the corresponding future time domain occasions 225 associated with the predictions.

In other cases, as noted previously herein, the measurement report 220 may indicate the K quantity of resources or beams that are expected to exhibit the best performance (e.g., sufficient performance, greater than a threshold) for respective time domain occasions 225, and may not explicitly indicate the predicted measurements/channel characteristics. For example, the reported predictions indicated via the measurement report 220 may include the predicted top-K-resources or beams in terms of L1-RSRP/L1-SINR strengths for the respective beams/resources, where the measurement report 220 does not actually explicitly indicate the actual L1-RSRP/L1-SINR values themselves.

For instance, in cases where K=3 (where the value of K may be configured by the network via reporting configuration 210, pre-defined, etc.), the measurement report 220 may indicate a first set of three beam or resource IDs that are expected/predicted to exhibit the best (or otherwise sufficient) performance for the first time domain occasion 225-a. Additionally, the measurement report 220 may indicate a second set of three beam or resource IDs that are expected/predicted to exhibit the best (or otherwise sufficient) performance for the second time domain occasion 225-b. In this example, the measurement report 220 may or may not explicitly indicate the predicted RSRP/SINR values for the beam or resource IDs reported for the respective time domain occasions 225. In such cases, the network entity 105-a may schedule the UE 115-a to perform communications within the time domain occasions 225 using the respective reported beam or resource IDs.

In some aspects, the measurement report 220 may indicate the reporting configuration 210 (e.g., ReportingConfigID for the reporting configuration 210) which was used to identify the time domain occasions 225 and generate the measurement report 220. In this regard, the network entity 105-a may be able to use the same reporting configuration 210 to identify the time domain occasions 225 that are associated with the predicted measurements indicated in the measurement report 220, and may use the reported correlations between future time domain occasions 225 and predicted measurements to improve an efficiency and reliability of communications scheduled at the UE 115-a.

For example, in some cases, the UE 115-a may select a reporting configuration 210 from a set of candidate reporting configurations 210 indicated by the network entity 105-a, and may indicate the selected reporting configuration 210 via the measurement report 220. Similarly, in cases where the control signaling 240 indicates parameters for a reporting configuration 210 (e.g., quantity of time domain occasions 225, earliest/latest time domain occasions 225, time intervals 230 between time domain occasions 225), the UE 115-a may determine a reporting configuration 210 based on the indicated parameters, and may indicate the determined reporting configuration 210 (and/or additional parameters of the reporting configuration 210) via the measurement report 220.

The UE 115-a may be configured to indicate which reporting configuration 210 was used to generate the measurement report 220 in various circumstances, and in accordance with different implementations. For example, in some cases, the network entity 105-a may indicate (via the control signaling 240) the total number of future time domain occasions 225 that are to be predicted, which may result in a CSI payload of a fixed size. In this example, the UE 115-a may identify a reporting configuration 210 that includes the indicated quantity of time domain occasions 225 (e.g., select a predefined ReportingConfigID with the indicated quantity of time domain occasions 225) and may indicate the ReportingConfigID to via the measurement report 220. For instance, the network entity 105-a may indicate (via the control signaling 240) that the CSI report should predict measurements for four future time domain occasions 225. In this example, relevant standards may predefine four separate reporting configurations including four future time domain occasions: (1) ReportingConfigID #1 with time domain occasions at 20-40-60-80 ms, (2) ReportingConfigID #2 with time domain occasions at 40-60-80-100 ms, (3) ReportingConfigID #3 with time domain occasions at 10-20-30-40 ms, and (4) ReportingConfigID #4 with time domain occasions at, 5-10-15-20 ms), where the relative offsets for the four time domain occasions 225 are measured relative to the slot carrying the CSI report and/or relative to the preceding time domain occasion 225. In this example, the UE 115-a may select one of the four predefined reporting configurations 210, and may indicate which reporting configuration 210 was selected (e.g., ReportingConfigID #1, #2, #3, or #4) was selected to generate the CSI report.

By way of another example, the network entity 105-a may configure/indicate multiple candidate reporting configurations 210 via the control signaling 240, where the UE 115-a may report an option-ID (e.g., ReportingConfigID) from the set of candidate reporting configurations 210. In this example, the different candidate reporting configurations 210 may be associated with different quantities of future time domain occasions 225, and may therefore result in different CSI payload sizes. As such, the UE 115-a may be configured to transmit the measurement report 220 (e.g., CSI report) as a PUSCH-based two-part CSI report, where the selected option-ID (e.g., ReportingConfigID) is indicated via a first part/portion of the two-part CSI report, and where the predicted measurements (e.g., L1-RSRPs and/or corresponding CMR-IDs) are indicated via the second part/portion of the two-part CSI report. Further, if the different candidate reporting configurations 210 may result in different CSI payload sizes, the UE 115-a may be able to choose the appropriate PUCCH resource without 2-part CSI reporting (e.g., one-part CSI reporting), in which case it may be up to network implementation (e.g., blind decoding) to determine which PUCCH resource was/is used to transmit the measurement report 220.

By way of yet another example, the network entity 105-a may configure/indicate a time domain window between the earliest time domain occasion 225-a and the latest time domain occasion 225-e. In this example, the UE 115-a may be configured to select/determine a reporting configuration 210 that includes/satisfies the indicated time domain window, and indicate the selected reporting configuration 210 via the CSI report. As noted previously herein, varying time domain windows may lead to different CSI payload sizes. As such, the UE 115-a may be configured to transmit the measurement report 220 (e.g., CSI report) using a PUSCH based 2-part CSI, wherein the option-ID reporting is in the first part and the L1-RSRPs and CMR-IDs associated with the L1-RSRPs are in the second part. Once again, if the different candidate reporting configurations 210 may result in different CSI payload sizes, the UE 115-a may be able to choose the appropriate PUCCH resource without 2-part CSI reporting (e.g., one-part CSI reporting), in which case it may be up to network implementation (e.g., blind decoding) to determine which PUCCH resource was/is used to transmit the measurement report 220.

In some cases, the network entity 105-a may utilize information in the measurement report 220 to schedule communications at the UE 115-a in a more efficient and reliable manner. In particular, the network entity 105-a may utilize information in the measurement report 220 to schedule communications at the UE 115-a such that the UE 115-a performs scheduled communications using Rx beams that are expected to exhibit sufficient (e.g., high) performance or quality.

For example, the network entity 105-a may transmit additional control signaling that includes scheduling information for a downlink message to be transmitted from the network entity 105-a to the UE 115-a, where the scheduling information is based on the measurement report 220. In particular, the network entity 105-a may schedule the downlink message such that the UE 115-a will receive the downlink message within (or proximate to) a future time domain occasion 225 using an Rx beam that is expected/predicted to sufficient performance (e.g., Rx beam associated with a predicted measurement that satisfies some threshold measurement, such as RSRP_{Predicted}≥RSRP_{Thresh}). In this regard, by reporting predicted measurements for future time domain occasions 225, techniques described herein may enable the network entity 105-a to perform more efficient and reliable scheduling at the UE 115-a. In other words, techniques described herein may enable the network entity 105-a to schedule communications such that the UE 115-a will perform scheduled communications using Rx beams that are expected to result in high RSRP/SINR measurements.

Techniques described herein may enable wireless devices to determine reporting configurations that will be used for future beam prediction, which may improve coordination between the network and wireless devices. By providing signaling, rules, and/or conditions usable for determining reporting configurations, techniques described herein may enable the network entity 105-a and the UE 115-a to use the same reporting configuration to determine which predicted measurements (e.g., predicted channel characteristics) reported by the UE 115-a correspond to which future time domain occasions, which may enable the network to more efficiently and reliably schedule communications at the UE 115-a. In particular, aspects of the present disclosure may enable the network to schedule future communications at the UE 115-a such that the UE 115-a will perform the future scheduled communications using Rx beams that are expected/predicted to exhibit sufficient performance.

FIG. 3 illustrates an example of a resource configuration 300 that supports techniques for identifying time domain occasions for beam prediction in accordance with one or more aspects of the present disclosure. In some examples, aspects of the resource configuration 300 may implement, or be implemented by, aspects of the wireless communications system 100, the wireless communications system 200, or both. In particular, the resource configuration 300 illustrates different reporting configurations 305-a, 305-b, and 305-c that may be used by respective wireless devices to determine time-domain occasions for future beam prediction, as described previously herein.

The respective reporting configurations 305 illustrate different examples where the network may indicate various parameters for a reporting configuration 305, and in which cases the UE 115 is configured with certain rules/configurations for identifying other parameters of the reporting configuration 305. In particular, as will be further described herein, a network entity 105 may be configured to indicate an earliest time domain occasion 310 and/or a latest time domain occasion 310 of a set of future time domain occasions 310, where the UE 115 may be configured to identify the total quantity of time domain occasions 310 that are to be predicted. Enabling the network entity 105 to indicate certain parameters of the reporting configuration 305 (and configuring the UE 115 with rules/conditions for determining the remaining parameters of the reporting configuration 305) may reduce control signaling overhead within the network.

For example, in some implementations, and in accordance with a CSI reporting setting, the network may configure one or more parameters of a reporting configuration (e.g., via control signaling 240 illustrated in FIG. 2). Parameters of a reporting configuration that may be configured/indicated by the network may include: (1) the time domain occasion 310 associated with the furthest prediction instance (e.g., latest time domain occasion 310), (2) the time domain occasion 310 associated with the nearest prediction instance (e.g., earliest time domain occasion 310), or both.

For example, referring to the first reporting configuration 305-a, the network may indicate relative timings of the earliest time domain occasion 310-a and/or the latest time domain occasion 310-b. As described previously herein, the relative timing of the respective time domain occasions 310 may be indicated via time domain offsets with respect to the TTI/slot carrying the CSI report and/or the TTI/slot including the CSI reference resource associated with the CSI report.

Continuing with the same example, the UE 115-a may be configured to identify other parameters associated with the reporting configuration 305 based on the relative timing of the earliest time domain occasion 310, the latest time domain occasion 310, or both. Other parameters that may be determined may include the total time interval 315 (e.g., prediction window) for beam prediction, time intervals between adjacent time domain occasions 310 (e.g., time intervals 230 in FIG. 2), a total quantity of time domain occasions 310 to be predicted, or any combination thereof. Stated differently, the network may indicate/configure a subset of parameters of a given reporting configuration 305, and the UE 115 may be configured to implicitly determine a remaining subset of parameters of the reporting configuration 305 based on the network configurations (e.g., indicated parameters) and/or standard preconfigured parameters.

In some cases, the UE 115 may implicitly determine remaining parameters of a reporting configuration 305 by comparing a total time interval 315 (e.g., prediction window) between the earliest and latest time domain occasions 310 to one or more threshold time durations.

For instance, referring to the first reporting configuration 305-a, the UE 115 may be configured to identify a time interval 315-a between the first/earliest time domain occasion 310-a and the latest time domain occasion 310-b (which may be indicated by the network). In this example, if the time interval 315-a is less than some threshold time duration (e.g., fails to satisfy Thresh₁), the UE 115 may be configured to determine that the reporting configuration 305-a includes only two time domain occasions 310 (e.g., the earliest time domain occasion 310-a and the latest time domain occasion 310-b). For instance, if the first threshold time duration (Thresh₁) is 100 ms, and the time interval 315-a is less than the first threshold time duration, then the UE 115 may determine that the reporting configuration 305-a includes only the earliest time domain occasion 310-a and the latest time domain occasion 310-b.

Referring now to the second reporting configuration 305-b, the network may indicate an earliest time domain occasion 310-c and/or a latest time domain occasion 310-f, and the UE 115 may be configured to identify a time interval 315-b between the earliest and latest time domain occasions 310. In this example, if the time interval 315-b is greater than the first threshold time duration (e.g., satisfies Thresh₁), but is less than a second threshold time duration (e.g., fails to satisfy Thresh₂), then the UE 115 may be configured to divide up the time interval 315-b into a (preconfigured) quantity of time domain occasions 310. For instance, if the time interval 315-b is greater than Thresh₁ (e.g., greater than 100 ms) but less than or equal to Thresh₂ (e.g., less than or equal to 300 ms), the UE 115 may equally/evenly divide up the time interval 315-b to identify four time domain occasions 310-c, 310-d, 310-e, and 310-f.

Referring now to the third reporting configuration 305-c, the network may indicate an earliest time domain occasion 310-g and/or a latest time domain occasion 310-n, and the UE 115 may be configured to identify a time interval 315-c between the earliest and latest time domain occasions 310. In this example, if the time interval 315-c is greater than the second threshold time duration (e.g., satisfies Thresh₂), then the UE 115 may be configured to divide up the time interval 315-b into a (preconfigured) quantity of time domain occasions 310. For instance, if the time interval 315-c is greater than or equal to Thresh₂ (e.g., greater than or equal to 300 ms), the UE 115 may equally/evenly divide up the time interval 315-b to identify eight time domain occasions 310-g, 310-h, 310-i, 310-j, 310-k, 310-l, 310-m, and 310-n.

In these examples, the respective thresholds (e.g., Thresh₁, Thresh₂), the rules for dividing up the time intervals 315 into certain quantities of time domain occasions 310, or both, may be preconfigured by the network, signaled to the UE 115, negotiated between the UE 115 and the network (e.g., based on UE 115 capability), or any combination thereof.

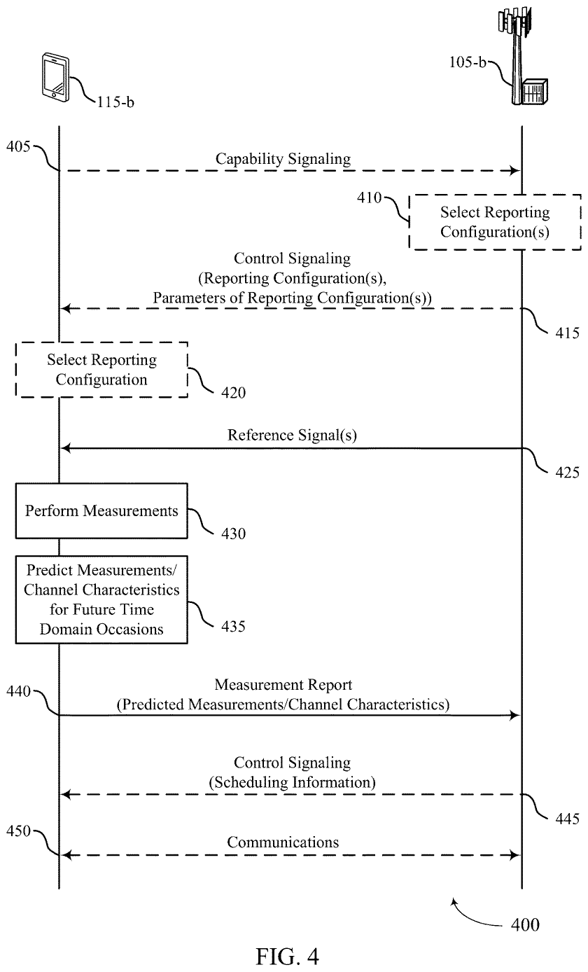

FIG. 4 illustrates an example of a process flow 400 that supports techniques for identifying time domain occasions for beam prediction in accordance with one or more aspects of the present disclosure. In some examples, aspects of the process flow 400 may implement, or be implemented by, aspects of wireless communications systems 100, the wireless communications system 200, the resource configuration 300, or any combination thereof. For example, process flow 400 illustrates techniques for determining or signaling measurement configurations for future time-domain beam prediction, as described previously herein.

The process flow 400 includes a UE 115-b and a network entity 105-b, which may be examples of wireless devices as described herein. For example, the UE 115-b and the network entity 105-b illustrated in FIG. 4 may include examples of the UE 115-a and the network entity 105-a, respectively, as illustrated in FIG. 2.

In some examples, the operations illustrated in process flow 400 may be performed by hardware (e.g., including circuitry, processing blocks, logic components, and other components), code (e.g., software or firmware) executed by a processor, or any combination thereof. Alternative examples of the following may be implemented, where some steps are performed in a different order than described or are not performed at all. In some cases, steps may include additional features not mentioned below, or further steps may be added.

At 405, the UE 115-b may transmit capability signaling to the network entity 105-b. The capability signaling may indicate one or more capabilities associated with the ability of the UE 115-b to perform future beam predictions, such as supported reporting configurations, processing capabilities, memory capabilities, and the like. For example, the capability signaling may indicate one or more reporting configurations usable for determining sets of future time domain occasions that are supported by the UE 115-b.

At 410, the network entity 105-b may determine or select one or more reporting configurations that may be used for future beam measurements/prediction at the UE 115-b. As described previously herein, each reporting configuration may include (or be associated with) one or more parameters that are usable by the respective devices for determining/identifying sets of future time domain occasions that will be used for future beam prediction.

In this regard, in some implementations, the network entity 105-b may additionally or alternatively determine/select one or more parameters for a reporting configuration, such as a quantity of time domain occasions that are to be predicted, relative timings of earliest/latest time domain occasions, time intervals between time domain occasions, and the like. In some implementations, relative timings of time domain occasions used for future beam prediction may be determined relative to a TTI/slot in which a measurement report (e.g., CSI report) is communicated, and/or relative to a TTI/slot associated with a reference resource (e.g., CSI reference resource) for the measurement report.

In some cases, the network entity 105-b may determine/select the one or more reporting configurations (and/or parameters for the reporting configuration(s)) based on the capability signaling received at 405. For example, the capability signaling may indicate a set of reporting configurations that are supported by the UE 115-b, and the network entity 105-b may select a subset of the reporting configurations as “candidate” reporting configurations that may be used by the UE 115-b.

At 415, the UE 115-b may receive, from the network entity 105-b, control signaling (e.g., RRC, SIB, DCI, MAC-CE) indicating one or more reporting configurations, one or more parameters for a reporting configuration, or both. In some aspects, the UE 115-b may receive the control signaling, and the network entity 105-b may transmit the control signaling, based on transmitting/receiving the capability signaling at 405, selecting the reporting configuration (and/or parameters of the reporting configuration) at 410, or both.

For example, in cases where the network entity 105-b selects a set of candidate reporting configurations at 410, the control signaling may indicate the set of candidate reporting configurations. By way of another example, in other cases, the control signaling may indicate one or more parameters usable by the UE 115-b for selecting/determining a reporting configuration that will be used, such as a quantity of time domain occasions that are to be predicted, relative timings of earliest/latest time domain occasions, time intervals between time domain occasions, time domain offsets for sets of future time domain occasions, and the like.

At 420, the UE 115-b may determine/select the reporting configuration (and/or additional parameters for the reporting configuration) that will be used for future beam prediction. The UE 115-b may determine/select the reporting configuration at 420 based on transmitting the capability signaling at 405, receiving the control signaling at 415, or both.

For example, in cases where the control signaling indicates a set of candidate reporting configurations, the UE 115-b may select one of the candidate reporting configurations. By way of another example, in other cases where the control signaling indicates one or more parameters for a reporting configuration, the UE 115-b may select a reporting configuration that is associated with (e.g., satisfies, includes) the indicated parameters. For instance, the control signaling may indicate time domain offsets for an earliest time domain occasion and/or a latest time domain occasion in a set of future time domain occasions used for future beam prediction. In this example, the UE 115-b may determine a quantity of time domain occasions of the reporting configuration based on the time domain offsets for the earliest/latest time domain occasions, relative time intervals between the respective time domain occasions, and the like.

In some aspects, the UE 115-b may select/determine the reporting configuration that will be used at 420 based on additional or alternative characteristics/parameters, such as a capability of the UE 115-b (e.g., processing capability, memory capability), a power level of the UE 115-b (e.g., battery level), characteristics of message traffic to be communicated to/from the UE 115-b (e.g., relative priority/importance of future communications, QoS), or any combination thereof.

At 425, the UE 115-b may receive one or more reference signals (e.g., CSI-RSs) from the network entity 105-b. In some cases, the reference signals may be received within CMRs which may be preconfigured and/or signaled to the UE 115-b (e.g., via the control signaling at 415). The UE 115-b may receive the reference signals, and the network entity 105-b may transmit the reference signals, based on transmitting/receiving the capability signaling at 405, selecting the reporting configuration(s) at 410 and/or 420, receiving/transmitting the control signaling at 415, or any combination thereof.

In some cases, the UE 115-b may receive the reference signals using one or more Rx beams at the UE 115-b. For example, the UE 115-b may cycle through a set of Rx beams to receive the reference signals in order to evaluate a relative effectiveness or quality of the respective Rx beams for communicating with the network entity 105-b.

At 430, the UE 115-b may perform a first set of measurements on the reference signals received at 425. The first set of measurements may include, but are not limited to, RSRP measurements (e.g., L1-RSRPs), SINR measurements (e.g., L1-SINRs), SNR measurements, RSRQ measurements, CQI measurements, or any combination thereof.

The UE 115-b may perform the first set of measurements at 430 order to evaluate a relative effectiveness or quality of the respective Rx beams for communicating with the network entity 105-b. For example, the UE 115-b may perform measurements for each respective Rx beam that was used to receive the reference signals at 425.

At 435, the UE 115-b may predict a second set of measurements (e.g., predict a set of future channel characteristics) associated with a set of future time domain occasions determined in accordance with the determined/indicated reporting configuration. In other words, the UE 115-b may predict measurements/channel characteristics (e.g., RSRP, SINR, SNR, RSRQ, CQI) for each respective time domain occasion associated with the determined reporting configuration. Moreover, the second set of predicted measurements may include predicted channel characteristics associated with the same or different Rx beams which were used to receive the reference signals at 425.

For example, the UE 115-b may determine/select the reporting configuration at 420, where the reporting configuration includes four time domain occasions (e.g., four occasions for future beam prediction). In this example, the UE 115-b may predict four measurements or channel characteristics (and/or four sets of measurements/channel characteristics) in accordance with the reporting configuration, with one predicted measurement (and/or one predicted set of measurements) for each respective time domain occasion. For instance, the UE 115-b may be configured to predict channel characteristics for three different Rx beams. In this example, the UE 115-b may predict a first set of three predicted measurements (one for each Rx beam) for the first time domain occasion, a second set of three predicted measurements for the second time domain occasion, a third set of three predicted measurements for the third time domain occasion, and a fourth set of three predicted measurements for the fourth time domain occasion.

At 440, the UE 115-b may transmit, to the network entity 105-b, a measurement report (e.g., CSI report) that indicates the second set of measurements (e.g., set of channel characteristics) which were predicted for the future time domain occasions at 435. The measurement report may additionally or alternatively indicate the first set of measurements which were performed on the reference signals at 430. The UE 115-b may transmit the measurement report at 440 based on transmitting the capability signaling at 405, receiving the control signaling at 415, determining/selecting the reporting configuration at 420, receiving the reference signals at 425, performing the first set of measurements at 430, predicting the second set of measurements at 435, or any combination thereof.

In some aspects, the measurement report may indicate the reporting configuration (e.g., reporting configuration ID) which was used to identify the time domain occasions and generate the measurement report. In this regard, the network entity 105-b may be able to use the same reporting configuration to identify the time domain occasions that are associated with the predicted measurements indicated in the measurement report, and may use the reported correlations between future time domain occasions and predicted measurements to improve an efficiency and reliability of communications scheduled at the UE 115-b.

For example, in some cases, the UE 115-b may select a reporting configuration from a set of candidate reporting configurations indicated by the network entity 105-b, and may indicate the selected reporting configuration via the measurement report. Similarly, in cases where the control signaling at 415 indicates parameters for a reporting configuration (e.g., quantity of time domain occasions, earliest/latest time domain occasions, time intervals between time domain occasions), the UE 115-b may determine a reporting configuration based on the indicated parameters, and may indicate the determined reporting configuration (and/or additional parameters of the reporting configuration) via the measurement report at 440.

At 445, the UE 115-b may receive, from the network entity 105-b, additional control signaling that indicates scheduling information for message traffic to be exchanged between the UE 115-b and the network entity 105-b. In some aspects, the network entity 105-b may determine the scheduling information and transmit the additional control signaling at 445 based on the measurement report at 440. In particular, the network entity 105-b may schedule communications at the UE 115-b based on the predicted measurements for the future time domain occasions which were indicated via the measurement report.

For example, the additional control signaling at 445 may schedule a downlink message to be transmitted from the network entity 105-b to the UE 115-b based on the measurement report. In particular, the network entity 105-b may schedule the downlink message such that the UE 115-b will receive the downlink message within (or proximate to) a future time domain occasion using an Rx beam that is expected/predicted to sufficient performance (e.g., Rx beam associated with a predicted measurement that satisfies some threshold measurement, such as RSRP_{Predicted}≥RSRP_{Thresh}). In this regard, by reporting predicted measurements for future time domain occasions, techniques described herein may enable the network entity 105-b to perform more efficient and reliable scheduling at the UE 115-b. In other words, techniques described herein may enable the network entity 105-b to schedule communications such that the UE 115-b will perform scheduled communications using Rx beams that are expected to result in high RSRP/SINR measurements.

At 450, the UE 115-b and the network entity 105-b may perform/exchange the scheduled communication with one another. For example, in cases where the additional control signaling at 445 schedules a downlink message (e.g., message traffic), the UE 115-b may receive the downlink message from the network entity 105-b in accordance with the scheduling information.

Techniques described herein may enable wireless devices to determine reporting configurations that will be used for future beam prediction, which may improve coordination between the network and wireless devices. By providing signaling, rules, and/or conditions usable for determining reporting configurations, techniques described herein may enable the network and the UE 115 to use the same reporting configuration to determine which predicted measurements reported by the UE 115-b correspond to which future time domain occasions, which may enable the network to more efficiently and reliably schedule communications at the UE 115-b. In particular, aspects of the present disclosure may enable the network to schedule future communications at the UE 11b such that the UE 115-b will perform the future scheduled communications using Rx beams that are expected/predicted to exhibit sufficient performance.

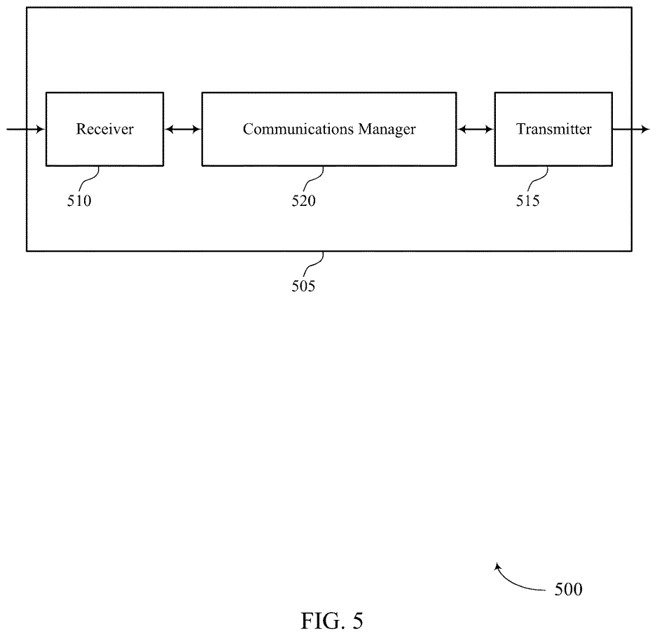

FIG. 5 illustrates a block diagram 500 of a device 505 that supports techniques for identifying time domain occasions for beam prediction in accordance with one or more aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to techniques for identifying time domain occasions for beam prediction). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to techniques for identifying time domain occasions for beam prediction). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of techniques for identifying time domain occasions for beam prediction as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

For example, the communications manager 520 may be configured as or otherwise support a means for performing a first set of measurements on a set of reference signals received from a network entity, the first set of measurements associated with one or more Rx beams at the UE used to receive the set of reference signals. The communications manager 520 may be configured as or otherwise support a means for predicting, based on the first set of measurements, a second set of measurements associated with a set of future time domain occasions determined in accordance with a reporting configuration, where the reporting configuration includes one or more parameters usable for determining the set of future time domain occasions including a quantity of time domain occasions in the set of future time domain occasions, an earliest time domain occasion in the set of future time domain occasions, a latest time domain occasion in the set of future time domain occasions, one or more time intervals between the set of future time domain occasions, or any combination thereof. The communications manager 520 may be configured as or otherwise support a means for transmitting, to the network entity, a measurement report indicating the second set of measurements predicted in accordance with the reporting configuration.

By including or configuring the communications manager 520 in accordance with examples as described herein, the device 505 (e.g., a processor controlling or otherwise coupled with the receiver 510, the transmitter 515, the communications manager 520, or a combination thereof) may support techniques that enable wireless devices to determine reporting configurations that will be used for future beam prediction, which may improve coordination between the network and wireless devices. By providing signaling, rules, and/or conditions usable for determining reporting configurations, techniques described herein may enable the network and the UE 115 to use the same reporting configuration to determine which predicted measurements reported by the UE 115 correspond to which future time domain occasions, which may enable the network to more efficiently and reliably schedule communications at the UE 115. In particular, aspects of the present disclosure may enable the network to schedule future communications at the UE 115 such that the UE 115 will perform the future scheduled communications using Rx beams that are expected/predicted to exhibit sufficient performance.

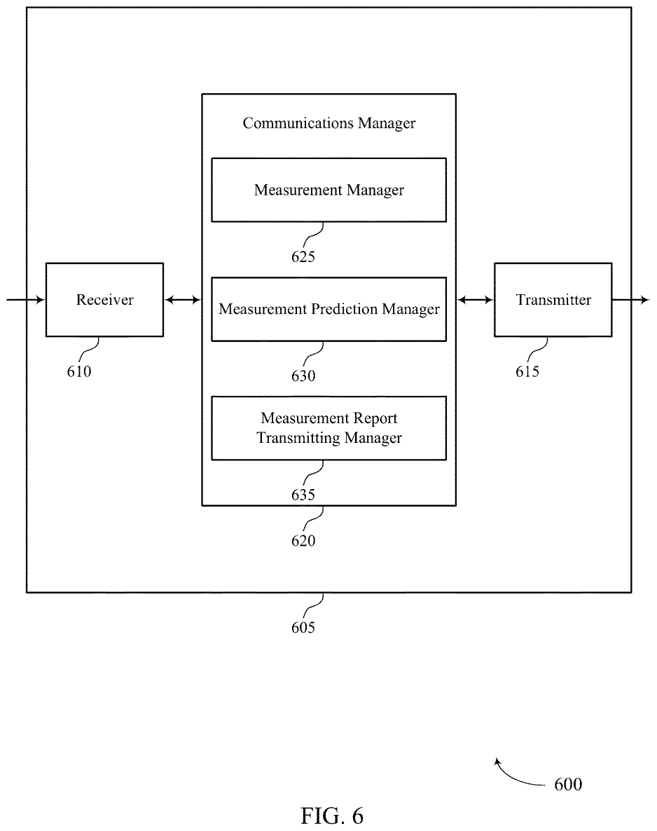

FIG. 6 illustrates a block diagram 600 of a device 605 that supports techniques for identifying time domain occasions for beam prediction in accordance with one or more aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for identifying time domain occasions for beam prediction). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for identifying time domain occasions for beam prediction). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of techniques for identifying time domain occasions for beam prediction as described herein. For example, the communications manager 620 may include a measurement manager 625, a measurement prediction manager 630, a measurement report transmitting manager 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The measurement manager 625 may be configured as or otherwise support a means for performing a first set of measurements on a set of reference signals received from a network entity, the first set of measurements associated with one or more Rx beams at the UE used to receive the set of reference signals. The measurement prediction manager 630 may be configured as or otherwise support a means for predicting, based on the first set of measurements, a second set of measurements associated with a set of future time domain occasions determined in accordance with a reporting configuration, where the reporting configuration includes one or more parameters usable for determining the set of future time domain occasions including a quantity of time domain occasions in the set of future time domain occasions, an earliest time domain occasion in the set of future time domain occasions, a latest time domain occasion in the set of future time domain occasions, one or more time intervals between the set of future time domain occasions, or any combination thereof. The measurement report transmitting manager 635 may be configured as or otherwise support a means for transmitting, to the network entity, a measurement report indicating the second set of measurements predicted in accordance with the reporting configuration.

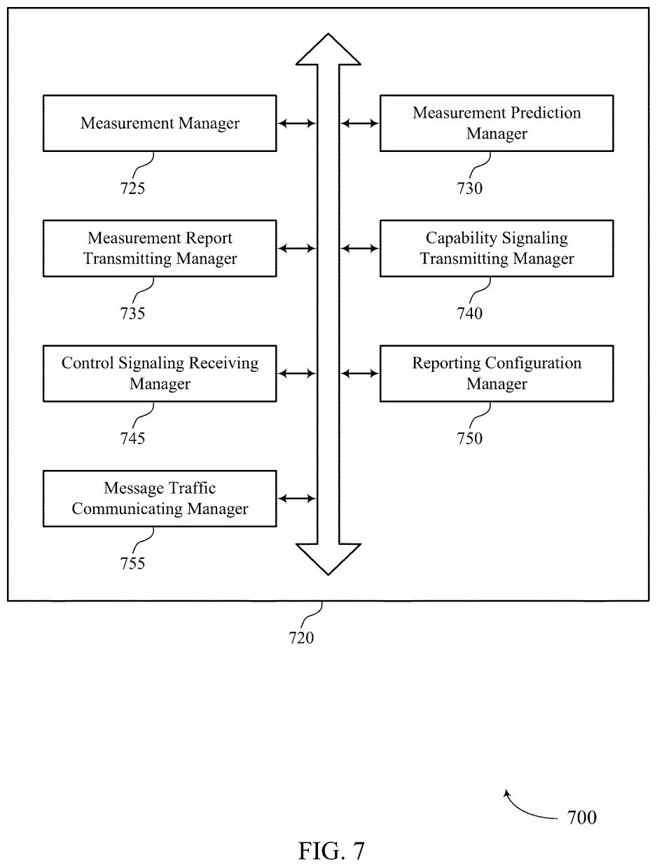

FIG. 7 illustrates a block diagram 700 of a communications manager 720 that supports techniques for identifying time domain occasions for beam prediction in accordance with one or more aspects of the present disclosure. The communications manager 720 may be an example of aspects of a communications manager 520, a communications manager 620, or both, as described herein. The communications manager 720, or various components thereof, may be an example of means for performing various aspects of techniques for identifying time domain occasions for beam prediction as described herein. For example, the communications manager 720 may include a measurement manager 725, a measurement prediction manager 730, a measurement report transmitting manager 735, a capability signaling transmitting manager 740, a control signaling receiving manager 745, a reporting configuration manager 750, a message traffic communicating manager 755, or any combination thereof. Each of these components may communicate, directly or indirectly, with one another (e.g., via one or more buses).

The measurement manager 725 may be configured as or otherwise support a means for performing a first set of measurements on a set of reference signals received from a network entity, the first set of measurements associated with one or more Rx beams at the UE used to receive the set of reference signals. The measurement prediction manager 730 may be configured as or otherwise support a means for predicting, based on the first set of measurements, a second set of measurements associated with a set of future time domain occasions determined in accordance with a reporting configuration, where the reporting configuration includes one or more parameters usable for determining the set of future time domain occasions including a quantity of time domain occasions in the set of future time domain occasions, an earliest time domain occasion in the set of future time domain occasions, a latest time domain occasion in the set of future time domain occasions, one or more time intervals between the set of future time domain occasions, or any combination thereof. The measurement report transmitting manager 735 may be configured as or otherwise support a means for transmitting, to the network entity, a measurement report indicating the second set of measurements predicted in accordance with the reporting configuration.

In some examples, the one or more parameters associated with the reporting configuration are usable for determining time offsets between the set of future time domain occasions and a first TTI within which the measurement report is transmitted, a second TTI associated with a reference resource for the measurement report, or both.

In some examples, the capability signaling transmitting manager 740 may be configured as or otherwise support a means for transmitting, to the network entity, capability signaling indicating one or more reporting configurations supported by the UE. In some examples, the control signaling receiving manager 745 may be configured as or otherwise support a means for receiving, from the network entity based on the capability signaling, control signaling indicating the reporting configuration included within the one or more reporting configurations, where predicting the second set of measurements is based on receiving the control signaling.

In some examples, the control signaling receiving manager 745 may be configured as or otherwise support a means for receiving, from the network entity, control signaling indicating one or more reporting configurations including the reporting configuration, where predicting the second set of measurements is based on receiving the control signaling.

In some examples, the reporting configuration manager 750 may be configured as or otherwise support a means for selecting the reporting configuration from the set of multiple reporting configurations based on a capability associated with the UE, a power level associated with the UE, one or more characteristics associated with message traffic to be communicated to or from the UE, or any combination thereof, where predicting the second set of measurements is based on the selecting.

In some examples, the measurement report transmitting manager 735 may be configured as or otherwise support a means for transmitting, via the measurement report, an indication of the reporting configuration selected from the set of multiple reporting configurations.

In some examples, the control signaling receiving manager 745 may be configured as or otherwise support a means for receiving, from the network entity, control signaling indicating the earliest time domain occasion in the set of future time domain occasions, the latest time domain occasion in the set of future time domain occasions, or both. In some examples, the reporting configuration manager 750 may be configured as or otherwise support a means for determining the reporting configuration based on the control signaling, where predicting the second set of measurements is based on the determining.

In some examples, the control signaling receiving manager 745 may be configured as or otherwise support a means for receiving, via the control signaling, an indication of a first time domain offset associated with the earliest time domain occasion, a second time domain offset associated with the latest time domain occasion, or both, where the first time domain offset includes an offset between the earliest time domain occasion and the first TTI or a second TTI associated with a reference resource associated with the measurement report, and where the second time domain offset includes an offset between the latest time domain occasion and the first TTI or the second TTI, and where determining the reporting configuration is based on the first time domain offset, the second time domain offset, or both.

In some examples, the reporting configuration manager 750 may be configured as or otherwise support a means for determining the quantity of time domain occasions in the set of future time domain occasions based on a time interval between the earliest time domain occasion and the latest time domain occasion.

In some examples, the reporting configuration manager 750 may be configured as or otherwise support a means for comparing the time interval to one or more threshold time durations, where determining the quantity of time domain occasions is based on the comparison.

In some examples, the measurement report transmitting manager 735 may be configured as or otherwise support a means for transmitting an indication of the reporting configuration via the measurement report.

In some examples, the control signaling receiving manager 745 may be configured as or otherwise support a means for receiving, from the network entity, control signaling indicating the quantity of time domain occasions within the set of future time domain occasions, a time interval between the earliest time domain occasion and the latest time domain occasion of the set of future time domain occasions, or both. In some examples, the reporting configuration manager 750 may be configured as or otherwise support a means for determining the reporting configuration based on the quantity of time domain occasions, the time interval, or both. In some examples, the measurement report transmitting manager 735 may be configured as or otherwise support a means for transmitting, via the measurement report, an indication of the reporting configuration.

In some examples, the second set of measurements are associated with the one or more Rx beams, one or more additional Rx beams at the UE, or both.

In some examples, the control signaling receiving manager 745 may be configured as or otherwise support a means for receiving, from the network entity and based on the measurement report, control signaling scheduling message traffic between the UE and the network entity. In some examples, the message traffic communicating manager 755 may be configured as or otherwise support a means for communicating the message traffic with the network entity based on receiving the control signaling. In some examples, the measurement report includes a CSI measurement report.

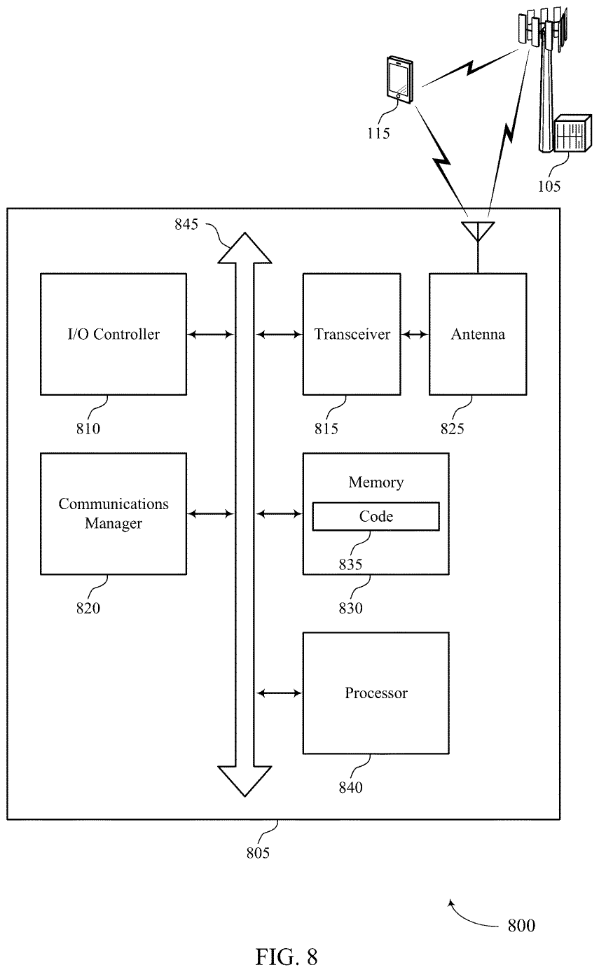

FIG. 8 illustrates a diagram of a system 800 including a device 805 that supports techniques for identifying time domain occasions for beam prediction in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting techniques for identifying time domain occasions for beam prediction). For example, the device 805 or a component of the device 805 may include a processor 840 and memory 830 coupled with or to the processor 840, the processor 840 and memory 830 configured to perform various functions described herein.

For example, the communications manager 820 may be configured as or otherwise support a means for performing a first set of measurements on a set of reference signals received from a network entity, the first set of measurements associated with one or more Rx beams at the UE used to receive the set of reference signals. The communications manager 820 may be configured as or otherwise support a means for predicting, based on the first set of measurements, a second set of measurements associated with a set of future time domain occasions determined in accordance with a reporting configuration, where the reporting configuration includes one or more parameters usable for determining the set of future time domain occasions including a quantity of time domain occasions in the set of future time domain occasions, an earliest time domain occasion in the set of future time domain occasions, a latest time domain occasion in the set of future time domain occasions, one or more time intervals between the set of future time domain occasions, or any combination thereof. The communications manager 820 may be configured as or otherwise support a means for transmitting, to the network entity, a measurement report indicating the second set of measurements predicted in accordance with the reporting configuration.

By including or configuring the communications manager 820 in accordance with examples as described herein, the device 805 may support techniques that enable wireless devices to determine reporting configurations that will be used for future beam prediction, which may improve coordination between the network and wireless devices. By providing signaling, rules, and/or conditions usable for determining reporting configurations, techniques described herein may enable the network and the UE 115 to use the same reporting configuration to determine which predicted measurements reported by the UE 115 correspond to which future time domain occasions, which may enable the network to more efficiently and reliably schedule communications at the UE 115. In particular, aspects of the present disclosure may enable the network to schedule future communications at the UE 115 such that the UE 115 will perform the future scheduled communications using Rx beams that are expected/predicted to exhibit sufficient performance.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of techniques for identifying time domain occasions for beam prediction as described herein, or the processor 840 and the memory 830 may be otherwise configured to perform or support such operations.

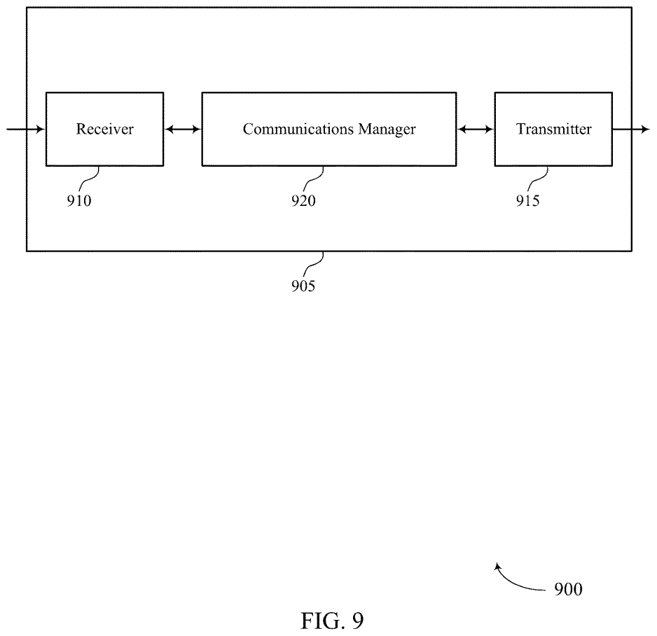

FIG. 9 illustrates a block diagram 900 of a device 905 that supports techniques for identifying time domain occasions for beam prediction in accordance with one or more aspects of the present disclosure. The device 905 may be an example of aspects of a network entity 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations thereof or various components thereof may be examples of means for performing various aspects of techniques for identifying time domain occasions for beam prediction as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

For example, the communications manager 920 may be configured as or otherwise support a means for transmitting a set of reference signals to a UE. The communications manager 920 may be configured as or otherwise support a means for receiving, from the UE based on transmitting the set of reference signals, a measurement report indicating a set of measurements associated with a set of future time domain occasions determined in accordance with a reporting configuration, where the reporting configuration includes one or more parameters usable for determining the set of future time domain occasions including a quantity of time domain occasions in the set of future time domain occasions, an earliest time domain occasion in the set of future time domain occasions, a latest time domain occasion in the set of future time domain occasions, one or more time intervals between the set of future time domain occasions, or any combination thereof. The communications manager 920 may be configured as or otherwise support a means for transmitting, to the UE, control signaling scheduling message traffic between the UE and the network entity based on the set of measurements.

By including or configuring the communications manager 920 in accordance with examples as described herein, the device 905 (e.g., a processor controlling or otherwise coupled with the receiver 910, the transmitter 915, the communications manager 920, or a combination thereof) may support techniques that enable wireless devices to determine reporting configurations that will be used for future beam prediction, which may improve coordination between the network and wireless devices. By providing signaling, rules, and/or conditions usable for determining reporting configurations, techniques described herein may enable the network and the UE 115 to use the same reporting configuration to determine which predicted measurements reported by the UE 115 correspond to which future time domain occasions, which may enable the network to more efficiently and reliably schedule communications at the UE 115. In particular, aspects of the present disclosure may enable the network to schedule future communications at the UE 115 such that the UE 115 will perform the future scheduled communications using Rx beams that are expected/predicted to exhibit sufficient performance.

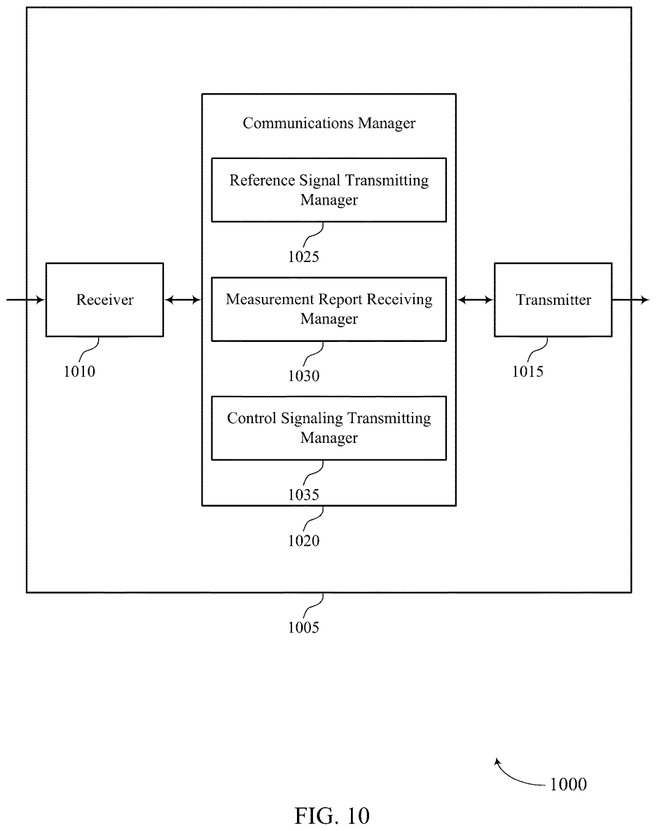

FIG. 10 illustrates a block diagram 1000 of a device 1005 that supports techniques for identifying time domain occasions for beam prediction in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of techniques for identifying time domain occasions for beam prediction as described herein. For example, the communications manager 1020 may include a reference signal transmitting manager 1025, a measurement report receiving manager 1030, a control signaling transmitting manager 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The reference signal transmitting manager 1025 may be configured as or otherwise support a means for transmitting a set of reference signals to a UE. The measurement report receiving manager 1030 may be configured as or otherwise support a means for receiving, from the UE based on transmitting the set of reference signals, a measurement report indicating a set of measurements associated with a set of future time domain occasions determined in accordance with a reporting configuration, where the reporting configuration includes one or more parameters usable for determining the set of future time domain occasions including a quantity of time domain occasions in the set of future time domain occasions, an earliest time domain occasion in the set of future time domain occasions, a latest time domain occasion in the set of future time domain occasions, one or more time intervals between the set of future time domain occasions, or any combination thereof. The control signaling transmitting manager 1035 may be configured as or otherwise support a means for transmitting, to the UE, control signaling scheduling message traffic between the UE and the network entity based on the set of measurements.

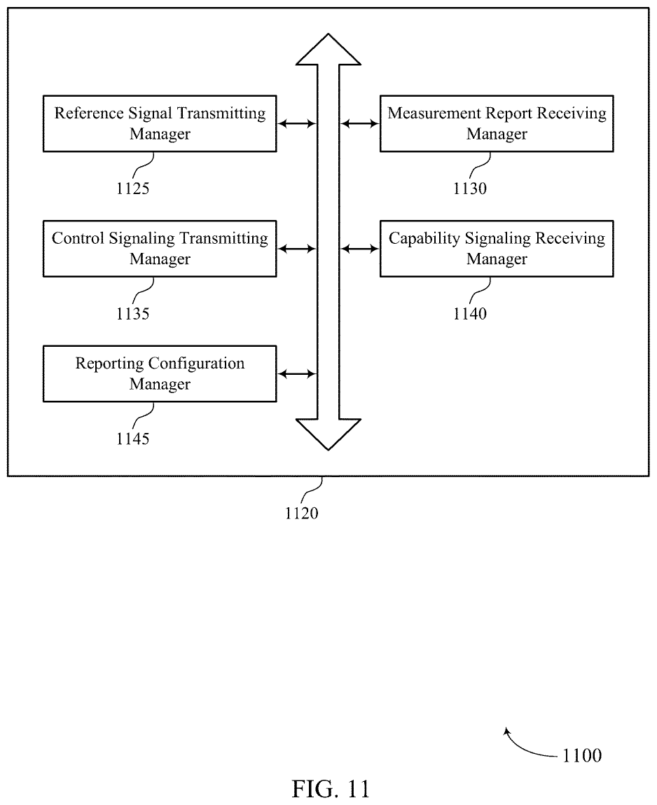

FIG. 11 illustrates a block diagram 1100 of a communications manager 1120 that supports techniques for identifying time domain occasions for beam prediction in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of techniques for identifying time domain occasions for beam prediction as described herein. For example, the communications manager 1120 may include a reference signal transmitting manager 1125, a measurement report receiving manager 1130, a control signaling transmitting manager 1135, a capability signaling receiving manager 1140, a reporting configuration manager 1145, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The reference signal transmitting manager 1125 may be configured as or otherwise support a means for transmitting a set of reference signals to a UE. The measurement report receiving manager 1130 may be configured as or otherwise support a means for receiving, from the UE based on transmitting the set of reference signals, a measurement report indicating a set of measurements associated with a set of future time domain occasions determined in accordance with a reporting configuration, where the reporting configuration includes one or more parameters usable for determining the set of future time domain occasions including a quantity of time domain occasions in the set of future time domain occasions, an earliest time domain occasion in the set of future time domain occasions, a latest time domain occasion in the set of future time domain occasions, one or more time intervals between the set of future time domain occasions, or any combination thereof. The control signaling transmitting manager 1135 may be configured as or otherwise support a means for transmitting, to the UE, control signaling scheduling message traffic between the UE and the network entity based on the set of measurements.

In some examples, the one or more parameters associated with the reporting configuration are usable for determining time offsets between the set of future time domain occasions and a first TTI within which the measurement report is received, a second TTI associated with a reference resource for the measurement report, or both.

In some examples, the capability signaling receiving manager 1140 may be configured as or otherwise support a means for receiving, from the UE, capability signaling indicating one or more reporting configurations supported by the UE. In some examples, the control signaling transmitting manager 1135 may be configured as or otherwise support a means for transmitting, to the UE based on the capability signaling, additional control signaling indicating the reporting configuration included within the one or more reporting configurations, where receiving the measurement report is based on transmitting the additional control signaling.

In some examples, the control signaling transmitting manager 1135 may be configured as or otherwise support a means for transmitting, to the UE, additional control signaling indicating one or more reporting configurations including the reporting configuration, where receiving the measurement report is based on transmitting the additional control signaling.

In some examples, the measurement report receiving manager 1130 may be configured as or otherwise support a means for receiving, via the measurement report, an indication of the reporting configuration selected by the UE from the set of multiple reporting configurations.

In some examples, the control signaling transmitting manager 1135 may be configured as or otherwise support a means for transmitting, to the UE, additional control signaling indicating the earliest time domain occasion in the set of future time domain occasions, the latest time domain occasion in the set of future time domain occasions, or both. In some examples, the reporting configuration manager 1145 may be configured as or otherwise support a means for determining the reporting configuration based on the additional control signaling, where receiving the measurement report is based on the additional control signaling.

In some examples, the control signaling transmitting manager 1135 may be configured as or otherwise support a means for transmitting, via the additional control signaling, an indication of a first time domain offset associated with the earliest time domain occasion, a second time domain offset associated with the latest time domain occasion, or both, where the first time domain offset includes an offset between the earliest time domain occasion and the first TTI or a second TTI associated with a reference resource associated with the measurement report, and where the second time domain offset includes an offset between the latest time domain occasion and the first TTI or the second TTI, and where determining the reporting configuration is based on the first time domain offset, the second time domain offset, or both.

In some examples, the reporting configuration manager 1145 may be configured as or otherwise support a means for determining the quantity of time domain occasions in the set of future time domain occasions based on a time interval between the earliest time domain occasion and the latest time domain occasion.

In some examples, the reporting configuration manager 1145 may be configured as or otherwise support a means for comparing the time interval to one or more threshold time durations, where determining the quantity of time domain occasions is based on the comparison.

In some examples, the measurement report receiving manager 1130 may be configured as or otherwise support a means for receiving an indication of the reporting configuration via the measurement report.

In some examples, the control signaling transmitting manager 1135 may be configured as or otherwise support a means for transmitting, to the UE, additional control signaling indicating the quantity of time domain occasions within the set of future time domain occasions, a time interval between the earliest time domain occasion and the latest time domain occasion of the set of future time domain occasions, or both. In some examples, the measurement report receiving manager 1130 may be configured as or otherwise support a means for receiving, via the measurement report, an indication of the reporting configuration, where the reporting configuration is based on the quantity of time domain occasions, the time interval, or both.

In some examples, the measurement report includes a CSI measurement report.

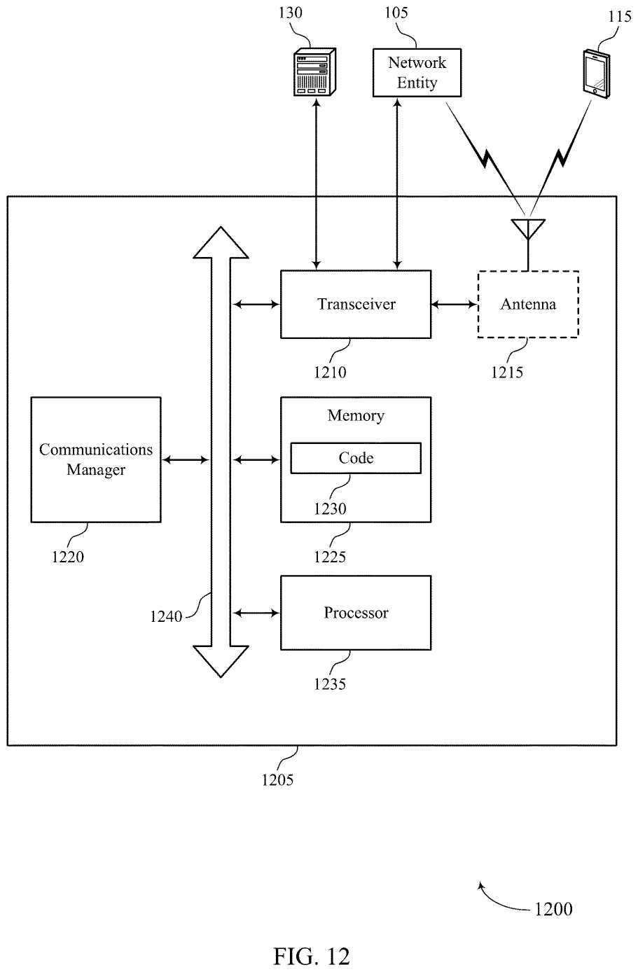

FIG. 12 illustrates a diagram of a system 1200 including a device 1205 that supports techniques for identifying time domain occasions for beam prediction in accordance with one or more aspects of the present disclosure. The device 1205 may be an example of or include the components of a device 905, a device 1005, or a network entity 105 as described herein. The device 1205 may communicate with one or more network entities 105, one or more UEs 115, or any combination thereof, which may include communications over one or more wired interfaces, over one or more wireless interfaces, or any combination thereof. The device 1205 may include components that support outputting and obtaining communications, such as a communications manager 1220, a transceiver 1210, an antenna 1215, a memory 1225, code 1230, and a processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or memory components (for example, the processor 1235, or the memory 1225, or both), may be included in a chip or chip assembly that is installed in the device 1205. In some examples, the transceiver may be operable to support communications via one or more communications links (e.g., a communication link 125, a backhaul communication link 120, a midhaul communication link 162, a fronthaul communication link 168).

The memory 1225 may include RAM and ROM. The memory 1225 may store computer-readable, computer-executable code 1230 including instructions that, when executed by the processor 1235, cause the device 1205 to perform various functions described herein. The code 1230 may be stored in a non-transitory computer-readable medium such as system memory or another type of memory. In some cases, the code 1230 may not be directly executable by the processor 1235 but may cause a computer (e.g., when compiled and executed) to perform functions described herein. In some cases, the memory 1225 may contain, among other things, a BIOS which may control basic hardware or software operation such as the interaction with peripheral components or devices.

The processor 1235 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1235 may be configured to operate a memory array using a memory controller. In some other cases, a memory controller may be integrated into the processor 1235. The processor 1235 may be configured to execute computer-readable instructions stored in a memory (e.g., the memory 1225) to cause the device 1205 to perform various functions (e.g., functions or tasks supporting techniques for identifying time domain occasions for beam prediction). For example, the device 1205 or a component of the device 1205 may include a processor 1235 and memory 1225 coupled with the processor 1235, the processor 1235 and memory 1225 configured to perform various functions described herein. The processor 1235 may be an example of a cloud-computing platform (e.g., one or more physical nodes and supporting software such as operating systems, virtual machines, or container instances) that may host the functions (e.g., by executing code 1230) to perform the functions of the device 1205. The processor 1235 may be any one or more suitable processors capable of executing scripts or instructions of one or more software programs stored in the device 1205 (such as within the memory 1225). In some implementations, the processor 1235 may be a component of a processing system. A processing system may generally refer to a system or series of machines or components that receives inputs and processes the inputs to produce a set of outputs (which may be passed to other systems or components of, for example, the device 1205). For example, a processing system of the device 1205 may refer to a system including the various other components or subcomponents of the device 1205, such as the processor 1235, or the transceiver 1210, or the communications manager 1220, or other components or combinations of components of the device 1205. The processing system of the device 1205 may interface with other components of the device 1205, and may process information received from other components (such as inputs or signals) or output information to other components. For example, a chip or modem of the device 1205 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1205 may transmit information output from the chip or modem. Additionally, or alternatively, in some implementations, the one or more interfaces may refer to an interface between the processing system of the chip or modem and a receiver, such that the device 1205 may obtain information or signal inputs, and the information may be passed to the processing system. A person having ordinary skill in the art will readily recognize that a first interface also may obtain information or signal inputs, and a second interface also may output information or signal outputs.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the memory 1225, the code 1230, and the processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with other network entities 105, and may include a controller or scheduler for controlling communications with UEs 115 in cooperation with other network entities 105. In some examples, the communications manager 1220 may support an X2 interface within an LTE/LTE-A wireless communications network technology to provide communication between network entities 105.

For example, the communications manager 1220 may be configured as or otherwise support a means for transmitting a set of reference signals to a UE. The communications manager 1220 may be configured as or otherwise support a means for receiving, from the UE based on transmitting the set of reference signals, a measurement report indicating a set of measurements associated with a set of future time domain occasions determined in accordance with a reporting configuration, where the reporting configuration includes one or more parameters usable for determining the set of future time domain occasions including a quantity of time domain occasions in the set of future time domain occasions, an earliest time domain occasion in the set of future time domain occasions, a latest time domain occasion in the set of future time domain occasions, one or more time intervals between the set of future time domain occasions, or any combination thereof. The communications manager 1220 may be configured as or otherwise support a means for transmitting, to the UE, control signaling scheduling message traffic between the UE and the network entity based on the set of measurements.

By including or configuring the communications manager 1220 in accordance with examples as described herein, the device 1205 may support techniques that enable wireless devices to determine reporting configurations that will be used for future beam prediction, which may improve coordination between the network and wireless devices. By providing signaling, rules, and/or conditions usable for determining reporting configurations, techniques described herein may enable the network and the UE 115 to use the same reporting configuration to determine which predicted measurements reported by the UE 115 correspond to which future time domain occasions, which may enable the network to more efficiently and reliably schedule communications at the UE 115. In particular, aspects of the present disclosure may enable the network to schedule future communications at the UE 115 such that the UE 115 will perform the future scheduled communications using Rx beams that are expected/predicted to exhibit sufficient performance.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, the processor 1235, the memory 1225, the code 1230, or any combination thereof. For example, the code 1230 may include instructions executable by the processor 1235 to cause the device 1205 to perform various aspects of techniques for identifying time domain occasions for beam prediction as described herein, or the processor 1235 and the memory 1225 may be otherwise configured to perform or support such operations.

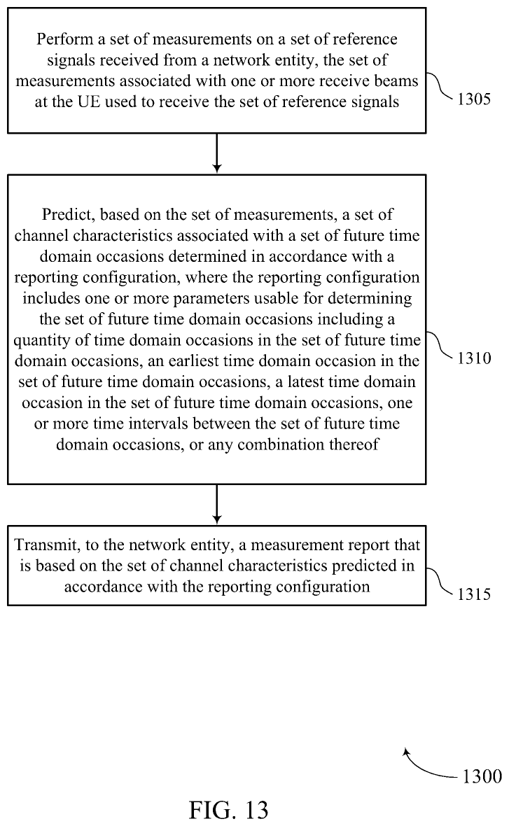

FIG. 13 illustrates a flowchart illustrating a method 1300 that supports techniques for identifying time domain occasions for beam prediction in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include performing a set of measurements on a set of reference signals received from a network entity, the set of measurements associated with one or more Rx beams at the UE used to receive the set of reference signals. The operations of 1305 may be performed in accordance with examples as disclosed herein. In some examples, aspects of the operations of 1305 may be performed by a measurement manager 725 as described with reference to FIG. 7.

At 1310, the method may include predicting, based on the set of measurements, a set of channel characteristics associated with a set of future time domain occasions determined in accordance with a reporting configuration, where the reporting configuration includes one or more parameters usable for determining the set of future time domain occasions including a quantity of time domain occasions in the set of future time domain occasions, an earliest time domain occasion in the set of future time domain occasions, a latest time domain occasion in the set of future time domain occasions, one or more time intervals between the set of future time domain occasions, or any combination thereof. The operations of 1310 may be performed in accordance with examples as disclosed herein. In some examples, aspects of the operations of 1310 may be performed by a measurement prediction manager 730 as described with reference to FIG. 7.

At 1315, the method may include transmitting, to the network entity, a measurement report that is based on the set of channel characteristics predicted in accordance with the reporting configuration. The operations of 1315 may be performed in accordance with examples as disclosed herein. In some examples, aspects of the operations of 1315 may be performed by a measurement report transmitting manager 735 as described with reference to FIG. 7.

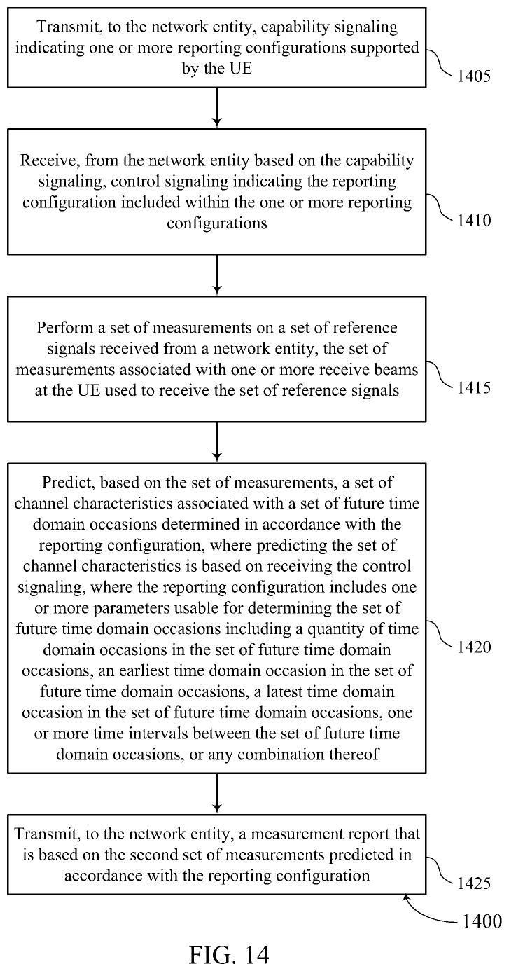

FIG. 14 illustrates a flowchart illustrating a method 1400 that supports techniques for identifying time domain occasions for beam prediction in accordance with one or more aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include transmitting, to the network entity, capability signaling indicating one or more reporting configurations supported by the UE. The operations of 1405 may be performed in accordance with examples as disclosed herein. In some examples, aspects of the operations of 1405 may be performed by a capability signaling transmitting manager 740 as described with reference to FIG. 7.

At 1410, the method may include receiving, from the network entity based on the capability signaling, control signaling indicating the reporting configuration included within the one or more reporting configurations. The operations of 1410 may be performed in accordance with examples as disclosed herein. In some examples, aspects of the operations of 1410 may be performed by a control signaling receiving manager 745 as described with reference to FIG. 7.

At 1415, the method may include performing a set of measurements on a set of reference signals received from a network entity, the set of measurements associated with one or more Rx beams at the UE used to receive the set of reference signals. The operations of 1415 may be performed in accordance with examples as disclosed herein. In some examples, aspects of the operations of 1415 may be performed by a measurement manager 725 as described with reference to FIG. 7.

At 1420, the method may include predicting, based on the set of measurements, a set of channel characteristics associated with a set of future time domain occasions determined in accordance with the reporting configuration, where predicting the set of channel characteristics is based on receiving the control signaling, where the reporting configuration includes one or more parameters usable for determining the set of future time domain occasions including a quantity of time domain occasions in the set of future time domain occasions, an earliest time domain occasion in the set of future time domain occasions, a latest time domain occasion in the set of future time domain occasions, one or more time intervals between the set of future time domain occasions, or any combination thereof. The operations of 1420 may be performed in accordance with examples as disclosed herein. In some examples, aspects of the operations of 1420 may be performed by a measurement prediction manager 730 as described with reference to FIG. 7.

At 1425, the method may include transmitting, to the network entity, a measurement report that is based on the set of channel characteristics predicted in accordance with the reporting configuration. The operations of 1425 may be performed in accordance with examples as disclosed herein. In some examples, aspects of the operations of 1425 may be performed by a measurement report transmitting manager 735 as described with reference to FIG. 7.

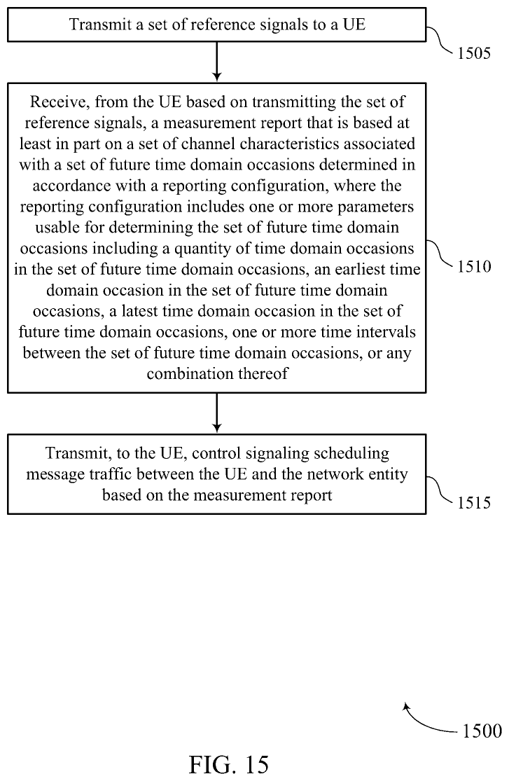

FIG. 15 illustrates a flowchart illustrating a method 1500 that supports techniques for identifying time domain occasions for beam prediction in accordance with one or more aspects of the present disclosure. The operations of the method 1500 may be implemented by a network entity or its components as described herein. For example, the operations of the method 1500 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1505, the method may include transmitting a set of reference signals to a UE. The operations of 1505 may be performed in accordance with examples as disclosed herein. In some examples, aspects of the operations of 1505 may be performed by a reference signal transmitting manager 1125 as described with reference to FIG. 11.

At 1510, the method may include receiving, from the UE based on transmitting the set of reference signals, a measurement report that is based on a set of channel characteristics associated with a set of future time domain occasions determined in accordance with a reporting configuration, where the reporting configuration includes one or more parameters usable for determining the set of future time domain occasions including a quantity of time domain occasions in the set of future time domain occasions, an earliest time domain occasion in the set of future time domain occasions, a latest time domain occasion in the set of future time domain occasions, one or more time intervals between the set of future time domain occasions, or any combination thereof. The operations of 1510 may be performed in accordance with examples as disclosed herein. In some examples, aspects of the operations of 1510 may be performed by a measurement report receiving manager 1130 as described with reference to FIG. 11.

At 1515, the method may include transmitting, to the UE, control signaling scheduling message traffic between the UE and the network entity based on the measurement report. The operations of 1515 may be performed in accordance with examples as disclosed herein. In some examples, aspects of the operations of 1515 may be performed by a control signaling transmitting manager 1135 as described with reference to FIG. 11.

The following provides an overview of aspects of the present disclosure:

Aspect 1: A method for wireless communication at a UE, comprising: performing a first set of measurements on a set of reference signals received from a network entity, the first set of measurements associated with one or more Rx beams at the UE used to receive the set of reference signals; predicting, based at least in part on the first set of measurements, a second set of measurements associated with a set of future time domain occasions determined in accordance with a reporting configuration, wherein the reporting configuration comprises one or more parameters usable for determining the set of future time domain occasions including a quantity of time domain occasions in the set of future time domain occasions, an earliest time domain occasion in the set of future time domain occasions, a latest time domain occasion in the set of future time domain occasions, one or more time intervals between the set of future time domain occasions, or any combination thereof; and transmitting, to the network entity, a measurement report indicating the second set of measurements predicted in accordance with the reporting configuration.

Aspect 2: The method of aspect 1, wherein the one or more parameters associated with the reporting configuration are usable for determining time offsets between the set of future time domain occasions and a first TTI within which the measurement report is transmitted, a second TTI associated with a reference resource for the measurement report, or both.

Aspect 3: The method of any of aspects 1 through 2, further comprising: transmitting, to the network entity, capability signaling indicating one or more reporting configurations supported by the UE; and receiving, from the network entity based at least in part on the capability signaling, control signaling indicating the reporting configuration included within the one or more reporting configurations, wherein predicting the second set of measurements is based at least in part on receiving the control signaling.

Aspect 4: The method of any of aspects 1 through 3, further comprising: receiving, from the network entity, control signaling indicating one or more reporting configurations including the reporting configuration, wherein predicting the second set of measurements is based at least in part on receiving the control signaling.

Aspect 5: The method of aspect 4, wherein the one or more reporting configurations comprise a plurality of reporting configurations, the method further comprising: selecting the reporting configuration from the plurality of reporting configurations based at least in part on a capability associated with the UE, a power level associated with the UE, one or more characteristics associated with message traffic to be communicated to or from the UE, or any combination thereof, wherein predicting the second set of measurements is based at least in part on the selecting.

Aspect 6: The method of aspect 5, further comprising: transmitting, via the measurement report, an indication of the reporting configuration selected from the plurality of reporting configurations.

Aspect 7: The method of any of aspects 1 through 6, further comprising: receiving, from the network entity, control signaling indicating the earliest time domain occasion in the set of future time domain occasions, the latest time domain occasion in the set of future time domain occasions, or both; and determining the reporting configuration based at least in part on the control signaling, wherein predicting the second set of measurements is based at least in part on the determining.

Aspect 8: The method of aspect 7, wherein the measurement report is transmitted within a first TTI, the method further comprising: receiving, via the control signaling, an indication of a first time domain offset associated with the earliest time domain occasion, a second time domain offset associated with the latest time domain occasion, or both, wherein the first time domain offset comprises an offset between the earliest time domain occasion and the first TTI or a second TTI associated with a reference resource associated with the measurement report, and wherein the second time domain offset comprises an offset between the latest time domain occasion and the first TTI or the second TTI, and wherein determining the reporting configuration is based at least in part on the first time domain offset, the second time domain offset, or both.

Aspect 9: The method of any of aspects 7 through 8, further comprising: determining the quantity of time domain occasions in the set of future time domain occasions based at least in part on a time interval between the earliest time domain occasion and the latest time domain occasion.

Aspect 10: The method of aspect 9, further comprising: comparing the time interval to one or more threshold time durations, wherein determining the quantity of time domain occasions is based at least in part on the comparison.

Aspect 11: The method of any of aspects 1 through 10, further comprising: transmitting an indication of the reporting configuration via the measurement report.

Aspect 12: The method of any of aspects 1 through 11, further comprising: receiving, from the network entity, control signaling indicating the quantity of time domain occasions within the set of future time domain occasions, a time interval between the earliest time domain occasion and the latest time domain occasion of the set of future time domain occasions, or both; determining the reporting configuration based at least in part on the quantity of time domain occasions, the time interval, or both; and transmitting, via the measurement report, an indication of the reporting configuration.

Aspect 13: The method of any of aspects 1 through 12, wherein the second set of measurements are associated with the one or more Rx beams, one or more additional Rx beams at the UE, or both.

Aspect 14: The method of any of aspects 1 through 13, further comprising: receiving, from the network entity and based at least in part on the measurement report, control signaling scheduling message traffic between the UE and the network entity; and communicating the message traffic with the network entity based at least in part on receiving the control signaling.

Aspect 15: The method of any of aspects 1 through 14, wherein the measurement report comprises a CSI measurement report.

Aspect 16: A method for wireless communication at a network entity, comprising: transmitting a set of reference signals to a UE; receiving, from the UE based at least in part on transmitting the set of reference signals, a measurement report indicating a set of measurements associated with a set of future time domain occasions determined in accordance with a reporting configuration, wherein the reporting configuration comprises one or more parameters usable for determining the set of future time domain occasions including a quantity of time domain occasions in the set of future time domain occasions, an earliest time domain occasion in the set of future time domain occasions, a latest time domain occasion in the set of future time domain occasions, one or more time intervals between the set of future time domain occasions, or any combination thereof; and transmitting, to the UE, control signaling scheduling message traffic between the UE and the network entity based at least in part on the set of measurements.

Aspect 17: The method of aspect 16, wherein the one or more parameters associated with the reporting configuration are usable for determining time offsets between the set of future time domain occasions and a first TTI within which the measurement report is received, a second TTI associated with a reference resource for the measurement report, or both.

Aspect 18: The method of any of aspects 16 through 17, further comprising: receiving, from the UE, capability signaling indicating one or more reporting configurations supported by the UE; and transmitting, to the UE based at least in part on the capability signaling, additional control signaling indicating the reporting configuration included within the one or more reporting configurations, wherein receiving the measurement report is based at least in part on transmitting the additional control signaling.

Aspect 19: The method of any of aspects 16 through 18, further comprising: transmitting, to the UE, additional control signaling indicating one or more reporting configurations including the reporting configuration, wherein receiving the measurement report is based at least in part on transmitting the additional control signaling.

Aspect 20: The method of aspect 19, wherein the one or more reporting configurations comprise a plurality of reporting configurations, the method further comprising: receiving, via the measurement report, an indication of the reporting configuration selected by the UE from the plurality of reporting configurations.

Aspect 21: The method of any of aspects 16 through 20, further comprising: transmitting, to the UE, additional control signaling indicating the earliest time domain occasion in the set of future time domain occasions, the latest time domain occasion in the set of future time domain occasions, or both; and determining the reporting configuration based at least in part on the additional control signaling, wherein receiving the measurement report is based at least in part on the additional control signaling.

Aspect 22: The method of aspect 21, wherein the measurement report is received within a first TTI, the method further comprising: transmitting, via the additional control signaling, an indication of a first time domain offset associated with the earliest time domain occasion, a second time domain offset associated with the latest time domain occasion, or both, wherein the first time domain offset comprises an offset between the earliest time domain occasion and the first TTI or a second TTI associated with a reference resource associated with the measurement report, and wherein the second time domain offset comprises an offset between the latest time domain occasion and the first TTI or the second TTI, and wherein determining the reporting configuration is based at least in part on the first time domain offset, the second time domain offset, or both.

Aspect 23: The method of any of aspects 21 through 22, further comprising: determining the quantity of time domain occasions in the set of future time domain occasions based at least in part on a time interval between the earliest time domain occasion and the latest time domain occasion.

Aspect 24: The method of aspect 23, further comprising: comparing the time interval to one or more threshold time durations, wherein determining the quantity of time domain occasions is based at least in part on the comparison.

Aspect 25: The method of any of aspects 16 through 24, further comprising: receiving an indication of the reporting configuration via the measurement report.

Aspect 26: The method of any of aspects 16 through 25, further comprising: transmitting, to the UE, additional control signaling indicating the quantity of time domain occasions within the set of future time domain occasions, a time interval between the earliest time domain occasion and the latest time domain occasion of the set of future time domain occasions, or both; and receiving, via the measurement report, an indication of the reporting configuration, wherein the reporting configuration is based at least in part on the quantity of time domain occasions, the time interval, or both.

Aspect 27: The method of any of aspects 16 through 26, wherein the measurement report comprises a CSI measurement report.

Aspect 28: An apparatus comprising a processor; memory coupled with the processor; and instructions stored in the memory and executable by the processor to cause the apparatus to perform a method of any of aspects 1 through 15.

Aspect 29: An apparatus comprising at least one means for performing a method of any of aspects 1 through 15.

Aspect 30: A non-transitory computer-readable medium storing code the code comprising instructions executable by a processor to perform a method of any of aspects 1 through 15.

Aspect 31: An apparatus comprising a processor; memory coupled with the processor; and instructions stored in the memory and executable by the processor to cause the apparatus to perform a method of any of aspects 16 through 27.

Aspect 32: An apparatus comprising at least one means for performing a method of any of aspects 16 through 27.

Aspect 33: A non-transitory computer-readable medium storing code the code comprising instructions executable by a processor to perform a method of any of aspects 16 through 27.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers.

Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communication at a user equipment (UE), comprising:
a processor;
memory coupled with the processor; and
instructions stored in the memory and executable by the processor to cause the apparatus to:
perform a set of measurements on a set of reference signals received from a network entity, the set of measurements associated with one or more receive beams at the UE used to receive the set of reference signals;
predict, based at least in part on the set of measurements, a set of channel characteristics associated with a set of future time domain occasions determined in accordance with a reporting configuration, wherein the reporting configuration comprises one or more parameters usable for determining the set of future time domain occasions including a quantity of time domain occasions in the set of future time domain occasions, an earliest time domain occasion in the set of future time domain occasions, a latest time domain occasion in the set of future time domain occasions, one or more time intervals between the set of future time domain occasions, or any combination thereof; and
transmit, to the network entity, a measurement report that is based at least in part on the set of channel characteristics predicted in accordance with the reporting configuration.

2. The apparatus of claim 1, wherein the one or more parameters associated with the reporting configuration are usable for determining time offsets between the set of future time domain occasions and a first transmission time interval within which the measurement report is transmitted, a second transmission time interval associated with a reference resource for the measurement report, or both.

3. The apparatus of claim 1, wherein the instructions are further executable by the processor to cause the apparatus to:
transmit, to the network entity, capability signaling indicating one or more reporting configurations supported by the UE; and
receive, from the network entity based at least in part on the capability signaling, control signaling indicating the reporting configuration included within the one or more reporting configurations, wherein predicting the set of channel characteristics is based at least in part on receiving the control signaling.

4. The apparatus of claim 1, wherein the instructions are further executable by the processor to cause the apparatus to:
receive, from the network entity, control signaling indicating one or more reporting configurations including the reporting configuration, wherein predicting the set of channel characteristics is based at least in part on receiving the control signaling.

5-6. (canceled)

7. The apparatus of claim 1, further comprising:
determine a set of resources usable for communications by the UE during the set of future time domain occasions based at least in part on the set of channel characteristics; and
transmit an indication of the set of resources via the measurement report.

8. The apparatus of claim 1, wherein the instructions are further executable by the processor to cause the apparatus to:
receive, from the network entity, control signaling indicating the earliest time domain occasion in the set of future time domain occasions, the latest time domain occasion in the set of future time domain occasions, or both; and
determine the reporting configuration based at least in part on the control signaling, wherein predicting the set of channel characteristics is based at least in part on the determining.

9-11. (canceled)

12. The apparatus of claim 1, wherein the instructions are further executable by the processor to cause the apparatus to:
transmit an indication of the reporting configuration via the measurement report.

13. The apparatus of claim 1, wherein the instructions are further executable by the processor to cause the apparatus to:
receive, from the network entity, control signaling indicating the quantity of time domain occasions within the set of future time domain occasions, a time interval between the earliest time domain occasion and the latest time domain occasion of the set of future time domain occasions, or both;
determine the reporting configuration based at least in part on the quantity of time domain occasions, the time interval, or both; and
transmit, via the measurement report, an indication of the reporting configuration.

14. The apparatus of claim 1, wherein the set of channel characteristics are associated with the one or more receive beams, one or more additional receive beams at the UE, or both.

15. The apparatus of claim 1, wherein the instructions are further executable by the processor to cause the apparatus to:
receive, from the network entity and based at least in part on the measurement report, control signaling scheduling message traffic between the UE and the network entity; and
communicate the message traffic with the network entity based at least in part on receiving the control signaling.

16. The apparatus of claim 1, wherein the measurement report comprises a channel state information measurement report.

17. An apparatus for wireless communication at a network entity, comprising:
a processor;
memory coupled with the processor; and
instructions stored in the memory and executable by the processor to cause the apparatus to:
transmit a set of reference signals to a user equipment (UE);
receive, from the UE based at least in part on transmitting the set of reference signals, a measurement report that is based at least in part on a set of channel characteristics associated with a set of future time domain occasions determined in accordance with a reporting configuration, wherein the reporting configuration comprises one or more parameters usable for determining the set of future time domain occasions including a quantity of time domain occasions in the set of future time domain occasions, an earliest time domain occasion in the set of future time domain occasions, a latest time domain occasion in the set of future time domain occasions, one or more time intervals between the set of future time domain occasions, or any combination thereof; and
transmit, to the UE, control signaling scheduling message traffic between the UE and the network entity based at least in part on the measurement report.

18. The apparatus of claim 17, wherein the one or more parameters associated with the reporting configuration are usable for determining time offsets between the set of future time domain occasions and a first transmission time interval within which the measurement report is received, a second transmission time interval associated with a reference resource for the measurement report, or both.

19. The apparatus of claim 17, wherein the instructions are further executable by the processor to cause the apparatus to:
receive, from the UE, capability signaling indicating one or more reporting configurations supported by the UE; and
transmit, to the UE based at least in part on the capability signaling, additional control signaling indicating the reporting configuration included within the one or more reporting configurations, wherein receiving the measurement report is based at least in part on transmitting the additional control signaling.

20. The apparatus of claim 17, wherein the instructions are further executable by the processor to cause the apparatus to:
transmit, to the UE, additional control signaling indicating one or more reporting configurations including the reporting configuration, wherein receiving the measurement report is based at least in part on transmitting the additional control signaling.

21. (canceled)

22. The apparatus of claim 17, further comprising:
receive, via the measurement report, an indication of a set of beams usable by the UE during the set of future time domain occasions, wherein the set of beams are based at least in part on the set of channel characteristics, and wherein the message traffic is scheduled during the set of future time domain occasions in accordance with the set of beams.

23. The apparatus of claim 17, wherein the instructions are further executable by the processor to cause the apparatus to:
transmit, to the UE, additional control signaling indicating the earliest time domain occasion in the set of future time domain occasions, the latest time domain occasion in the set of future time domain occasions, or both; and
determine the reporting configuration based at least in part on the additional control signaling, wherein receiving the measurement report is based at least in part on the additional control signaling.

24-26. (canceled)

27. The apparatus of claim 17, wherein the instructions are further executable by the processor to cause the apparatus to:
receive an indication of the reporting configuration via the measurement report.

28. The apparatus of claim 17, wherein the instructions are further executable by the processor to cause the apparatus to:
transmit, to the UE, additional control signaling indicating the quantity of time domain occasions within the set of future time domain occasions, a time interval between the earliest time domain occasion and the latest time domain occasion of the set of future time domain occasions, or both; and
receive, via the measurement report, an indication of the reporting configuration, wherein the reporting configuration is based at least in part on the quantity of time domain occasions, the time interval, or both.

29. A method for wireless communication at a user equipment (UE), comprising:
performing a set of measurements on a set of reference signals received from a network entity, the set of measurements associated with one or more receive beams at the UE used to receive the set of reference signals;
predicting, based at least in part on the set of measurements, a set of channel characteristics associated with a set of future time domain occasions determined in accordance with a reporting configuration, wherein the reporting configuration comprises one or more parameters usable for determining the set of future time domain occasions including a quantity of time domain occasions in the set of future time domain occasions, an earliest time domain occasion in the set of future time domain occasions, a latest time domain occasion in the set of future time domain occasions, one or more time intervals between the set of future time domain occasions, or any combination thereof; and
transmitting, to the network entity, a measurement report that is based at least in part on the set of channel characteristics predicted in accordance with the reporting configuration.

30. (canceled)
